(19) United States
(12) Patent Application Publication
(10) Pub. No.: US 2026/0251240 A1
(43) Pub. Date: Aug. 27, 2026

(54) PIPE ELEMENT, COUPLING AND ROLLER SET

(71) Applicant: VICTAULIC COMPANY, Easton, PA (US)

(72) Inventors: Christopher A. Richards, Saylorsburg, PA (US); Matthew A. Bowman, Palmer, PA (US); Thomas Nunnally, Telford, PA (US); Scott D. Madara, Nazareth, PA (US); Michael R. Novitsky, Slatington, PA (US); William Gushue, Bangor, PA (US)

(21) Appl. No.: 19/546,322

(22) Filed: Feb. 21, 2026

Related U.S. Application Data
(60) Provisional application No. 63/761,629, filed on Feb. 21, 2025.

(51) Int. Cl. F16L 9/00; F16L 9/02; F16L 21/06

(52) U.S. Cl. CPC F16L 9/006; F16L 9/02; F16L 21/065

(57) ABSTRACT

A pipe element has an endform comprising a circumferential groove and a bead. The groove is positioned proximate an end of the pipe element and is defined by a first groove side surface, a second groove side surface, and a floor surface. The groove is positioned between the end of the pipe element and the bead. The bead has a summit and a first bead side surface positioned between the second groove side surface and the summit. When a pipe element is inserted into a coupling, the bead engages an arcuate projection of the coupling to position and align the arcuate projection with the groove, facilitating assembly without manual alignment. When the coupling is tightened, the arcuate projection wedges into the groove, promoting a rigid joint. A roller set has an outer roller and an inner roller with raised features that cooperate to roll form the endform.

### CROSS REFERENCE TO RELATED APPLICATIONS

This application is based upon and claims priority to U.S. Provisional Application No. 63/761,629, filed Feb. 21, 2025, which application is hereby incorporated by reference in its entirety.

### FIELD

This disclosure concerns improved endforms for pipe elements joined by mechanical couplings, couplings having keys compatible with improved endforms, and rollers for forming the improved endforms in pipe elements.

### BACKGROUND

Obtaining rigid connections in grooved coupling joints is challenging due to many factors, including that grooved coupling joints rely on a smaller key of the coupling fitting into a larger groove, creating the opportunity for some “play” between those components that reduces rigidity. It is known in the art to improve the rigidity, including the axial, angular, and torsional rigidity, of grooved coupling connections by clamping the groove forcefully, e.g., forcing the arcuate surface of the key forcefully against the floor of the groove to increase the friction and slightly ovalize the pipe cross-section to increase rigidity. It is also known to utilize grooved couplings with angled bolt pads that, as the bolts are tightened, cause the segments to rotate relative to one another to cause local contact at the sidewalls of the groove in order to more firmly grip the pipe. However, both of these methods have drawbacks, especially as piping is made thinner, as clamping the groove floor is dependent on pipe stiffness, and thinner pipe is less stiff. Similarly, the contact on the side of the grooves created by the angled pad style couplings is localized and does not act around the groove circumference.

Grooved couplings that are pre-assembled are known, and often have gaskets that have a radially-inwardly projecting tongue designed to serve as a “stop” that locates the keys of the couplings relative to the groove such that the assembly can be properly completed. Couplings without such tongues rely on manual alignment of the coupling keys with the groove, which may result in increased misassembly. However, the tongues increase the width of the gasket, which increases the width of the housings and generally makes the couplings heavier and harder to use.

### SUMMARY

In one aspect, an example pipe element has a sidewall surrounding a longitudinal axis and defining a bore. The longitudinal axis is a central axis of the pipe element. The sidewall has an outer surface. The sidewall comprises an endform and a tubular portion connected to the endform. The endform extends from an end of the pipe element to the tubular portion. The endform comprises a groove defined by the outer surface of the sidewall. The groove extends circumferentially around the bore. The groove comprises a first groove side surface terminating at a first end, a second groove side surface facing the first groove side surface and in spaced apart relation from the first groove side surface, and a floor surface contiguous with (connected, either directly or through a transition region, to) the first groove side surface and the second groove side surface. The first groove side surface is positioned between the end of the pipe element and the second groove side surface. The groove is configured to receive an arcuate projection of a coupling. The endform further comprises a bead defined by the outer surface. The bead extends circumferentially around the bore. The groove is positioned between the end of the pipe element and the bead. The bead comprises a first bead side surface and a first summit. The first bead side surface is positioned between the groove and the first summit.

In another aspect, an example pipe element and an example coupling are provided in combination. The pipe element has a sidewall surrounding a longitudinal axis and defining a bore. The longitudinal axis is a central axis of the pipe element. The sidewall has an outer surface. The sidewall comprises an endform and a tubular portion connected to the endform. The endform extends from an end of the pipe element to the tubular portion. The endform comprises a groove defined by the outer surface of the sidewall. The groove extends circumferentially around the bore. The groove comprises a first groove side surface, a second groove side surface facing the first groove side surface and in spaced apart relation from the first groove side surface, and a floor surface contiguous with (connected, either directly or through a transition region, to) the first groove side surface and the second groove side surface. The first groove side surface is positioned between the end of the pipe element and the second groove side surface. The endform further comprises a bead defined by the outer surface. The bead extends circumferentially around the bore. The bead comprises a first bead side surface contiguous with (connected, either directly or through a transition region, to) the second groove side surface and a first summit having a radius measured from the longitudinal axis. The first bead side surface is positioned between the first summit and the second groove side surface. The coupling comprises a plurality of segments attached to one another end to end surrounding the end of the pipe element. The attached plurality of segments form a loop around a central space. Attachment members are positioned at each end of the segments for attaching the segments to one another. An arcuate projection is positioned on a side of each of the segments and is configured to engage with the groove. The arcuate projection projects radially inwardly from the side. The arcuate projection comprises a first mating surface configured to engage the first groove side surface, a second mating surface facing away from the first mating surface and configured to engage the second groove side surface, and a third mating surface contiguous with (connected, either directly or through a transition region, to) the first mating surface and the second mating surface and facing the central space. The third mating surface is positioned between the first mating surface and the second mating surface. When received by the groove, the arcuate projection is configured to wedge into the groove.

In another aspect, an example method of assembling a combination of a pipe element and a coupling is provided. The pipe element has a sidewall surrounding a longitudinal axis and defining a bore. The longitudinal axis is a central axis of the pipe element. The sidewall has an outer surface comprising an endform. The endform comprises a groove defined by the outer surface. The groove extends circumferentially around the bore. The endform further comprises a bead defined by the outer surface. The bead is adjacent to (optionally, immediately adjacent to) or contiguous with the groove. The coupling comprises a plurality of segments attached to one another end to end forming a loop around a central space. Attachment members are provided for attaching the segments to one another. An arcuate projection is positioned on a side of each of the segments. The method comprises inserting the pipe element end first into the central space of the coupling in a preassembled state until at least one of the groove and the bead engages the arcuate projection. The method further comprises adjusting the attachment members to draw the plurality of segments from an initial condition to a tightened condition, wherein the arcuate projection wedges into the groove.

In another aspect, an example method of forming a pipe element is provided. The pipe element has a sidewall surrounding a longitudinal axis and defining a bore. The longitudinal axis is a central axis of the pipe element. The sidewall has an outer surface and an inner surface. The method comprises positioning the inner surface of the pipe element on an inner roller of a roller set. The inner roller comprises an inner roller body rotatable about an inner roller axis. The method further comprises moving an outer roller of the roller set into contact with the outer surface of the pipe element. The outer roller comprises an outer roller body rotatable about an outer roller axis. The method further comprises rotating the inner roller, thereby rotating the pipe element and the outer roller. The method further comprises forcing the inner and outer rollers toward one another to deform the pipe element to form an endform. The endform comprises a groove defined by the outer surface. The groove extends circumferentially around the bore. The groove comprises a first groove side surface, a second groove side surface facing the first groove side surface and in spaced apart relation from the first groove side surface, and a floor surface contiguous with (or connected, either directly or through a transition region, to) the first groove side surface and the second groove side surface. The first groove side surface and the second groove side surface are configured to receive an arcuate projection of a coupling. The endform further comprises a bead defined by the outer surface. The bead comprises a first bead side surface and a summit. The first bead side surface is positioned between the summit and the second groove side surface.

In another aspect, an example roller set is provided. The roller set comprises an outer roller engageable with an outer surface of a pipe element. The outer roller comprises an outer roller body rotatable about an outer roller axis. The outer roller body has an outer surface comprising a first raised feature engageable with the pipe element and extending circumferentially about the outer roller body and projecting radially away from the outer roller axis, a second raised feature engageable with the pipe element and extending circumferentially about the outer roller body and projecting radially away from the outer roller axis, a third raised feature engageable with the pipe element and extending circumferentially about the outer roller body and projecting radially away from the outer roller axis, a first portion positioned between the first raised feature and the second raised feature of the outer roller body, and a second portion positioned between the second raised feature and the third raised feature of the outer roller body. The second raised feature is positioned between the first and third raised features. A radius of the outer surface at the second portion of the outer roller body is less than a radius of the outer surface at the first portion of the outer roller body. The roller set further comprises an inner roller engageable with an inner surface of the pipe element. The inner roller comprises an inner roller body rotatable about an inner roller axis. The inner roller body has an outer surface comprising a flange extending circumferentially around the inner roller body and projecting transversely to the inner roller axis, a fourth raised feature engageable with the pipe element and extending circumferentially about the inner roller body and projecting radially away from the inner roller axis, a fifth raised feature engageable with the pipe element and extending circumferentially about the inner roller body and projecting radially away from the inner roller axis, a third portion positioned between the flange and the fourth raised feature, and a fourth portion positioned between the fourth raised feature and the fifth raised feature. The fourth raised feature is positioned between the flange and the fifth raised feature. The fifth raised feature has a radius greater than a radius of the fourth raised feature.

In another aspect, an example outer roller is provided for use with an inner roller to roll form an endform of a pipe element. The outer roller is engageable with an outer surface of the pipe element. The outer roller comprises an outer roller body rotatable about an outer roller axis. The outer roller body has an outer surface comprising a first raised feature engageable with the pipe element and extending circumferentially about the outer roller body and projecting radially away from the outer roller axis, a second raised feature engageable with the pipe element and extending circumferentially about the outer roller body and projecting radially away from the outer roller axis, a third raised feature engageable with the pipe element and extending circumferentially about the outer roller body and projecting radially away from the outer roller axis, a first portion positioned between the first raised feature and the second raised feature of the outer roller body, and a second portion positioned between the second raised feature and the third raised feature of the outer roller body. The second raised feature is positioned between the first and third raised features. A radius of the outer surface at the second portion of the outer roller body is less than a radius of the outer surface at the first portion of the outer roller body.

In another aspect, an example inner roller is provided for use with an outer roller to roll form an endform of a pipe element. The inner roller is engageable with an inner surface of the pipe element. The inner roller comprises an inner roller body rotatable about an inner roller axis. The inner roller body has an outer surface comprising a flange extending circumferentially around the inner roller body and projecting transversely to the inner roller axis, a fourth raised feature engageable with the pipe element and extending circumferentially about the inner roller body and projecting radially away from the inner roller axis, a fifth raised feature engageable with the pipe element and extending circumferentially about the inner roller body and projecting radially away from the inner roller axis, a third portion positioned between the flange and the fourth raised feature, and a fourth portion positioned between the fourth raised feature and the fifth raised feature. The fourth raised feature is positioned between the flange and the fifth raised feature. The fifth raised feature has a radius greater than a radius of the fourth raised feature.

In another aspect, an example method for forming an endform of a pipe element using a roller set is provided. The pipe element has a sidewall surrounding a longitudinal axis and defining a bore. The sidewall has an outer surface and an inner surface. The roller set comprises an outer roller and an inner roller. The outer roller comprises an outer roller body rotatable about an outer roller axis. The outer roller body has an outer surface comprising a first raised feature, a second raised feature, and a third raised feature engageable with the pipe element and extending circumferentially about the outer roller body and projecting radially away from the outer roller axis. The second raised feature is positioned between the first and third raised features. The outer roller body further has a first portion positioned between the first raised feature and the second raised feature, and a second portion positioned between the second raised feature and the third raised feature. A radius of the outer surface at the second portion is less than a radius of the outer surface at the first portion. The inner roller comprises an inner roller body rotatable about an inner roller axis. The inner roller body has an outer surface comprising a flange extending circumferentially around the inner roller body and projecting transversely to the inner roller axis, a fourth raised feature and a fifth raised feature engageable with the pipe element and extending circumferentially about the inner roller body and projecting radially away from the inner roller axis, a third portion positioned between the flange and the fourth raised feature, and a fourth portion positioned between the fourth raised feature and the fifth raised feature. The fourth raised feature is positioned between the flange and the fifth raised feature. The fifth raised feature has a radius greater than a radius of the fourth raised feature. The method comprises positioning the inner surface of the pipe element on the inner roller and into contact with the fifth raised feature. The method further comprises moving the outer roller into contact with the outer surface of the pipe element. The method further comprises rotating the inner roller, thereby rotating the pipe element and the outer roller. The method further comprises forcing the inner and outer rollers toward one another to deform the pipe element to form the endform.

In another aspect, an example pipe element has a sidewall surrounding a longitudinal axis and defining a bore. The sidewall has an outer surface and an inner surface. The sidewall comprises an endform formed by a process. The process comprises positioning the inner surface of the pipe element on an inner roller of a roller set. The inner roller comprises an inner roller body rotatable about an inner roller axis. The inner roller body has an outer surface comprising a flange extending circumferentially around the inner roller body and projecting transversely to the inner roller axis, a fourth raised feature and a fifth raised feature engageable with the pipe element and extending circumferentially about the inner roller body and projecting radially away from the inner roller axis. The fourth raised feature is positioned between the flange and the fifth raised feature. The fifth raised feature has a radius greater than a radius of the fourth raised feature. The process further comprises moving an outer roller of the roller set into contact with the outer surface of the pipe element. The outer roller comprises an outer roller body rotatable about an outer roller axis. The outer roller body has an outer surface comprising a first raised feature, a second raised feature, and a third raised feature engageable with the pipe element and extending circumferentially about the outer roller body and projecting radially away from the outer roller axis. The second raised feature is positioned adjacent to (optionally, immediately adjacent to) or contiguous with the first raised feature and between the first and third raised features. The process further comprises rotating the inner roller, thereby rotating the pipe element and the outer roller. The process further comprises forcing the inner and outer rollers toward one another to deform the pipe element to form the endform.

### BRIEF DESCRIPTION OF THE DRAWINGS

FIG. 1 is an isometric view of an example coupling joining together example pipe elements according to the disclosure;

FIG. 2 is an isometric view of an example pipe element according to the disclosure;

FIG. 3 is an isometric view of an example pipe element that is an example elbow fitting according to the disclosure;

FIG. 4 is an isometric view of an example pipe element that is an example tee fitting according to the disclosure;

FIG. 5 is a front side view of the pipe element shown in FIG. 2;

FIG. 6 is a front side view of a second embodiment of the pipe element;

FIG. 7 is a front side view of a third embodiment of the pipe element;

FIG. 8 is a front side view of a fourth embodiment of the pipe element;

FIG. 9 is a front side view of a fourth embodiment of the pipe element;

FIG. 10 is a left end view of the pipe element shown in FIG. 2;

FIG. 11 is a cross-sectional view of the pipe element taken along section line 11-11 in FIG. 10;

FIG. 12 is an isometric view of an example coupling according to the disclosure;

FIG. 13 is a front side view of the coupling shown in FIG. 12;

FIG. 14 is a right end view of the coupling shown in FIG. 12;

FIG. 15 is a top plan view of the coupling shown in FIG. 12;

FIG. 16 is a front side view of a second embodiment of the coupling;

FIG. 17 is a front side view of a third embodiment of the coupling;

FIG. 18 is a cross-sectional view of the combination coupling and pipe elements taken along section line 18,19-18,19 in FIG. 1 in a tightened condition under a first tolerance;

FIG. 19 is a cross-sectional view of the combination coupling and pipe elements taken along section line 18,19-18,19 in FIG. 1 in a tightened condition under a second tolerance;

FIG. 20 shows a cross-sectional view of a portion of an example combination coupling and pipe elements with the coupling in a preassembled state in an initial condition;

FIG. 21 shows a cross-sectional view of a portion of an example combination coupling and pipe elements with the coupling in a preassembled state in an initial condition;

FIG. 22 shows a cross-sectional view of a portion of the example combination coupling and pipe elements with the coupling in an intermediate condition;

FIG. 23 shows a cross sectional view of a portion of the example combination coupling and pipe elements with the coupling in a tightened condition;

FIG. 24 is an isometric view of a fourth embodiment of the coupling;

FIG. 25 is a front side view of the example coupling shown in FIG. 24;

FIG. 26 is a right end view of the example coupling shown in FIG. 24;

FIG. 27 is a top plan view of the example coupling shown in FIG. 24;

FIG. 28 is an isometric view of an example combination coupling and pipe elements according to the disclosure;

FIG. 29 is an isometric view of an example combination coupling and pipe elements according to the disclosure;

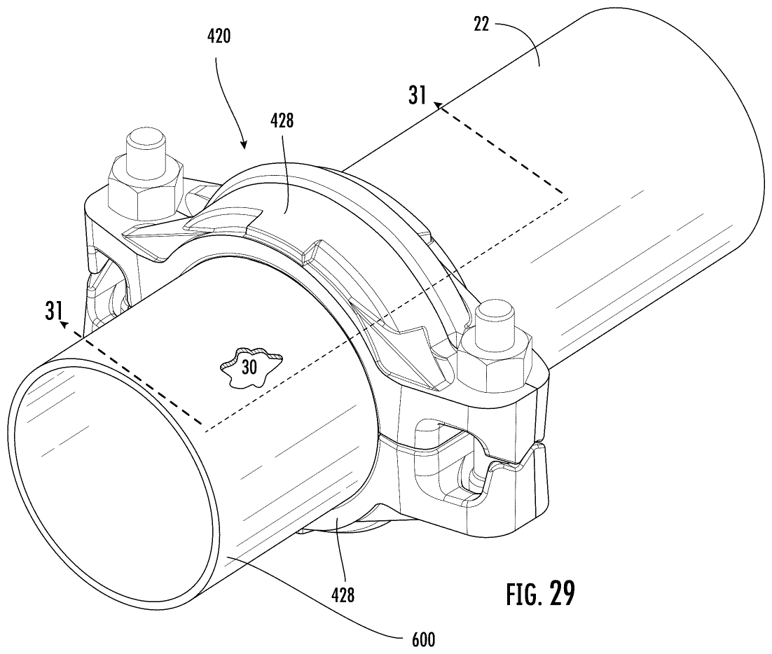

FIG. 30 is a front side view of the example combination coupling and pipe elements shown in FIG. 29;

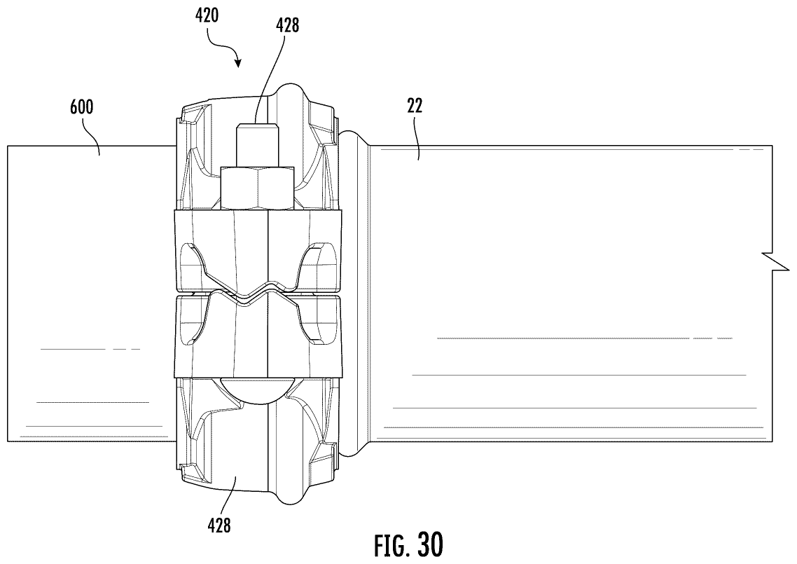

FIG. 31 is a partial cross-sectional view of the example combination coupling and pipe elements taken along section line 31-31 in FIG. 29;

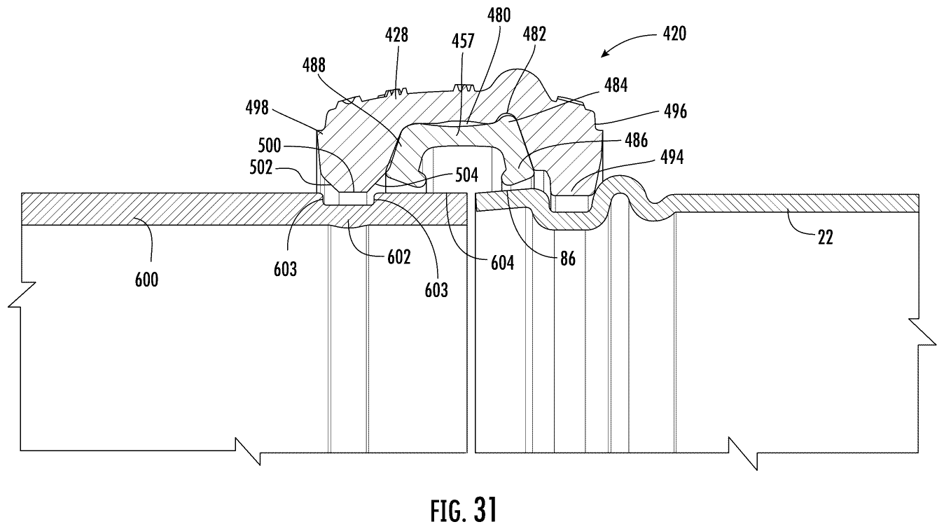

FIG. 32 shows a side view of an example roller set and pipe element according to the disclosure;

FIG. 33 shows a left end view of the roller set and pipe element shown in FIG. 26;

FIG. 34 shows a cross sectional view of the roller set and pipe element taken along section line 34-34 in FIG. 33;

FIG. 35 is a magnified view of area 35 shown in FIG. 34;

FIG. 36 is a magnified view of area 36 shown in FIG. 34; and

FIG. 37 shows a front view of an example pipe element according to the disclosure inserted end first into the central space of an example preassembled coupling according to the disclosure.

### DETAILED DESCRIPTION

The present disclosure can be understood more readily by reference to the accompanying detailed description, which includes examples, claims and drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a channel” can represent disclosure of embodiments in which only a single channel is provided, and unless the context dictates otherwise, can also represent disclosure of embodiments in which a plurality of such channels are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each (e.g., A and B, A and C, B and C, or A, B, and C).

As used herein “pipe” or “pipe element” is intended to mean any fluid pipe-like component including, but not limited to, pipe stock, pipe fittings such as elbows, caps and tees, as well as fluid control components such as valves, reducers, strainers, restrictors, pressure regulators and the like. When a feature is described herein with respect to a “pipe” or a “pipe element,” it is understood that such description represents disclosure of that feature with respect to a specific form of “pipe” or “pipe element” as indicated above. For example, unless otherwise indicated, description of a feature with respect to a “pipe element” is intended to provide disclosure of a pipe fitting having the described feature.

As used herein, when referencing the point or region where two surfaces or features come together, the term “transition,” “transition region,” or “transitions” means a change from one surface or portion to another surface or portion via practical geometric forms such as arcs, fillets, chamfers, and other more generalized concave or convex features, inflections, or blends between the surfaces or features, it being understood that perfectly flat surfaces or sharp corners may not be practical and in many cases undesirable. The term “transition,” “transition region,” or “transitions” may comprise edge portions at either or both ends of surfaces or features described herein.

As used herein, the term “contiguous” means that two surfaces are connected, either directly or through a transition region. Two contiguous surfaces may share a common edge or boundary, or may be connected by a transition region therebetween. As described herein, the transition region may comprise a radiused surface, a chamfered surface, a fillet, or other transitional geometry connecting the two surfaces. For example, a first surface and a second surface that are contiguous may meet at an apparently sharp edge, or may be connected by a curved or radiused transition region extending between the first surface and the second surface. In some aspects, a transition region connecting two contiguous surfaces may have a length or peripheral dimension that is less than a length or peripheral dimension of either of the two surfaces being connected. In some aspects, and without limitation, a transition region connecting two contiguous surfaces may have a length or peripheral dimension of less than about 10 mm, less than about 5 mm, less than about 3 mm, or less than about 1 mm. These dimensions are provided by way of example only and are not intended to limit the scope of the term “contiguous” or the dimensions of any transition region. The term “contiguous” does not require that the two surfaces be coplanar or tangent to one another.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree of the stated position or orientation.

The word “or” as used herein means any one member of a particular list and, in alternative embodiments, unless context dictates otherwise, can include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the device, systems, and associated methods can be implemented and used without employing these specific details. Indeed, the device, systems, and associated methods can be placed into practice by modifying the illustrated device, systems, and associated methods and may be used in conjunction with any other apparatus and techniques conventionally used in the industry.

### Overview

Various embodiments of pipe elements, couplings, rollers, combinations, and corresponding methods are disclosed. As further discussed herein, it is contemplated that the disclosed pipe elements, couplings, and/or rollers can be used to address or improve upon one or more of the deficiencies of existing grooved coupling joints. For example, it is contemplated that the disclosure can enable or provide grooved couplings having increased or improved rigidity. As another example, it is contemplated that the disclosure can allow for or provide preassembled grooved couplings that do not have tongues but which cooperate with pipe elements that automatically align keys to the groove. It is further contemplated that such grooved couplings can decrease the required width of the gasket and coupling, thereby leading to decreased coupling weight and improved ease of use.

The grooved mechanical pipe couplings disclosed herein may be used to join pipe elements in end to end relation. The example grooved pipe elements disclosed herein have endforms comprising a circumferential groove and a bead formed in an outer surface of the pipe element proximate an end thereof. An example mechanical coupling disclosed herein comprises segments that are attached to one another to surround the ends of the pipe elements to be joined. Each segment has an arcuate projection, also known as a key, that projects radially inwardly and engages the groove of the pipe element. A seal or gasket is typically positioned within the coupling to provide a fluid-tight seal between the pipe elements.

The disclosed pipe elements have an endform comprising a groove that is configured to receive an arcuate projection of a grooved mechanical coupling. As disclosed herein, the geometry of the arcuate projections and the groove may promote wedging of the arcuate projection into the groove, including around the circumference of the pipe element, which may increase the rigidity of the joint. Unlike conventional grooves and keys that may allow slippage before the sidewalls of the key contact the sidewalls of the groove, the disclosed arcuate projection may axially fill the groove to prevent unwanted slippage and promote a more rigid joint.

The wedging action of the arcuate projection and the groove promotes a more rigid joint. The disclosed couplings may promote wedging by producing forceful contact between the arcuate projections of the segments and the first groove side surface and the second groove side surface of the groove over a broad tolerance range of groove diameters and a broad tolerance range of diameters of the arcuate projection surfaces. The wedging of the arcuate projection into the groove may provide more consistent engagement around the pipe circumference and may address the limitations of conventional angled pad style couplings that may provide only localized contact at the groove sidewalls.

The groove of the pipe element is positioned between the end of the pipe element and the bead. In exemplary configurations, the bead has a summit with a radius greater than any other radius of the outer surface of the endform from the end of the pipe element to the summit. The position of the bead facilitates the alignment of the groove relative to the arcuate projection of the coupling. Optionally, the bead of the pipe element is positioned adjacent (optionally, immediately adjacent) or contiguous with the groove. When a pipe element is inserted into a coupling in a preassembled state, the bead contacts a portion of the coupling, such as the arcuate projection, to position and align the arcuate projection with the groove, facilitating assembly without manual alignment. The geometry of the arcuate projection and the endform of the pipe element may therefore facilitate alignment and engagement between the groove and arcuate projection of a coupling without relying on contact between the pipe element and a tongue or center leg on the seal, and without requiring manual alignment of the arcuate projection and groove.

The disclosed roller sets may be used to roll form the endform of the pipe element, including the groove and bead. The roller sets may comprise an outer roller and an inner roller that cooperate to deform the pipe element to form the endform. The outer roller may have raised features that form the groove and bead, and the inner roller may have raised features that support the inner surface of the pipe element during the roll forming process.

### Combination of Grooved Coupling and Pipe Elements

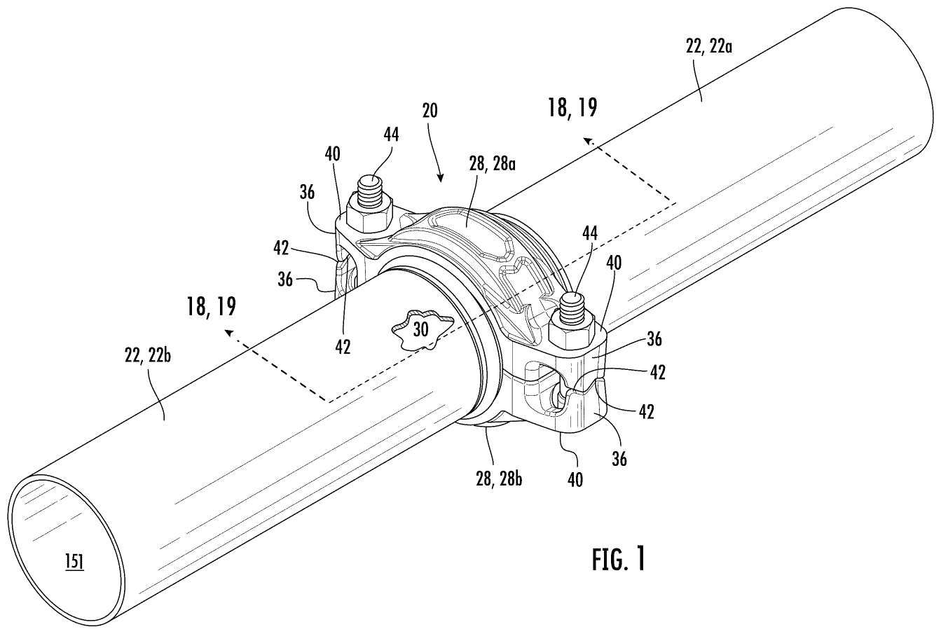

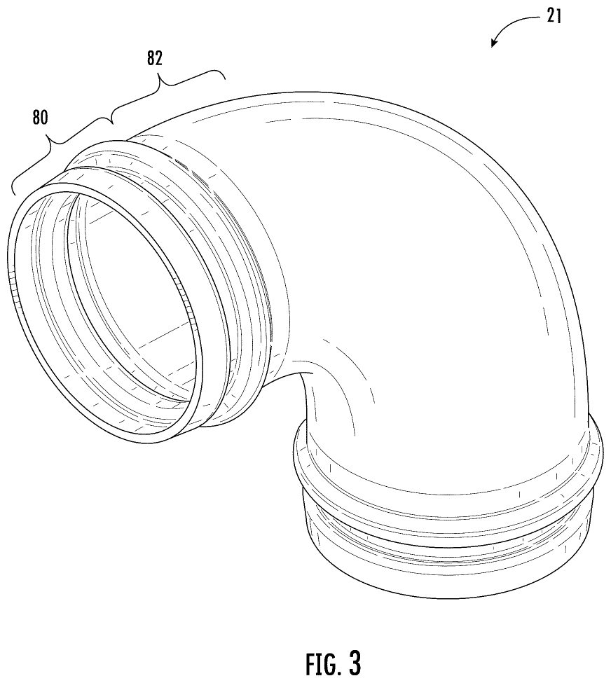

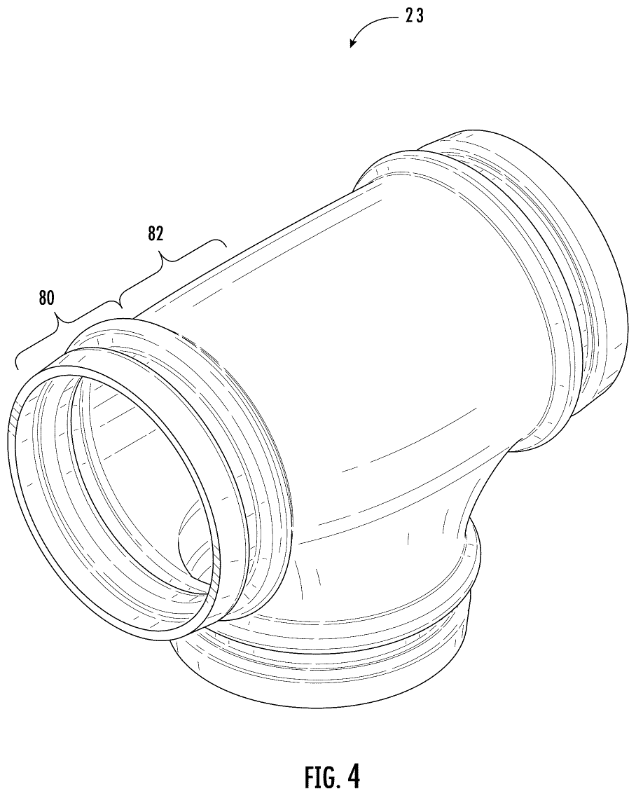

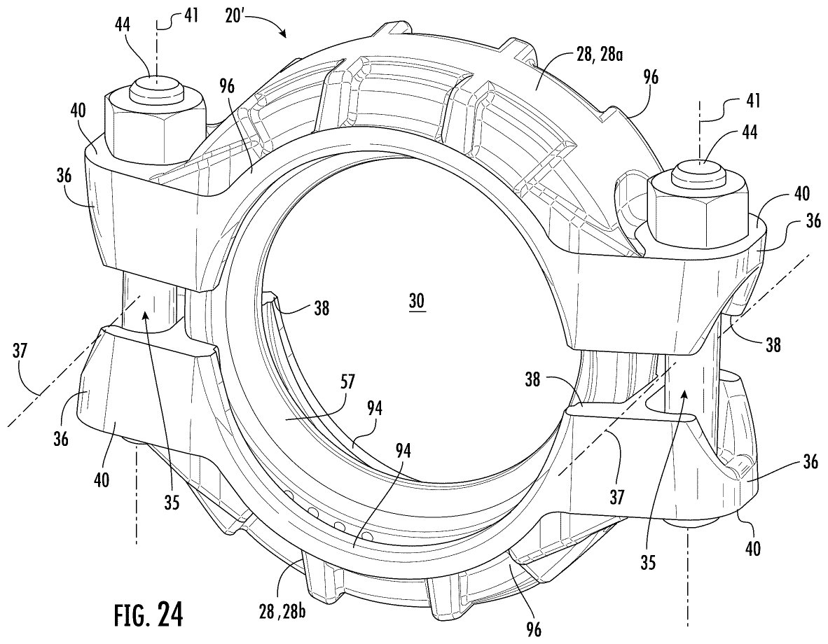

FIGS. 1 and 24 show an example grooved mechanical pipe coupling 20, 20′ according to the disclosure joining example pipe elements 22, in this example a first pipe element 22a and a second pipe element 22b, according to the disclosure. As previously defined, each pipe element 22 can be any fluid pipe-like component including, but not limited to, pipe stock, pipe fittings such as elbows (see example elbow 21 shown in FIG. 3), caps and tees (see example tee 23 shown in FIG. 4), as well as fluid control components such as valves, reducers, strainers, restrictors, pressure regulators and the like. Coupling 20, 20′ comprises a plurality of segments 28, in this example a first segment 28a and a second segment 28b, configured to attach to one another end to end to surround a central space 30. The plurality of segments 28 are configured to be attached to one another end to end to surround (e.g., by forming a loop or annular structure around) the central space 30. The plurality of segments 28 are configured to surround the ends of the pipe elements 22a, 22b. Attachment of the segments 28a, 28b to one another is effected by attachment members 36 positioned at each end of the segments 28a, 28b. Attachment members 36 are configured to draw the segments 28a, 28b together to a tightened condition as described herein to join the first pipe element 22a to the second pipe element 22b. Exemplary pipe elements 22 and grooved pipe couplings 20, 20′, which can be provided and used together or independently of one another, are discussed further below.

### Pipe Elements

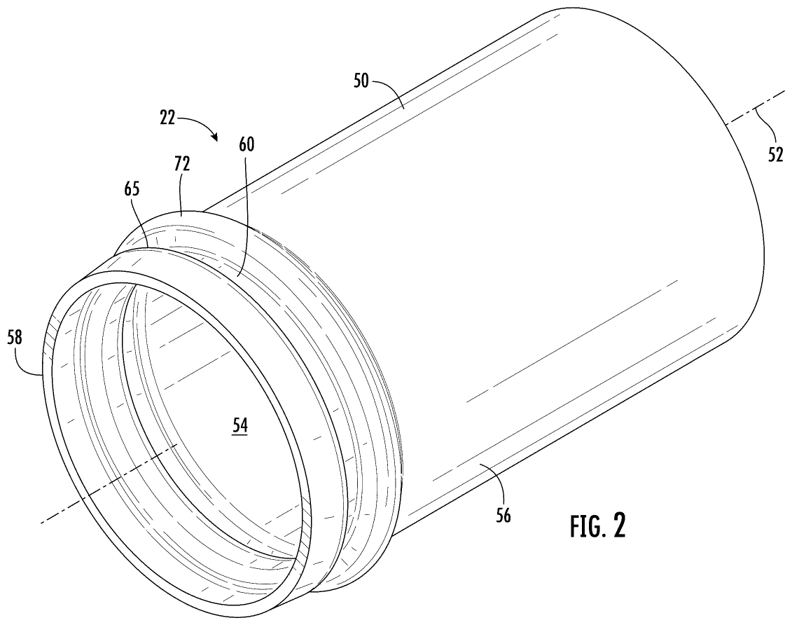

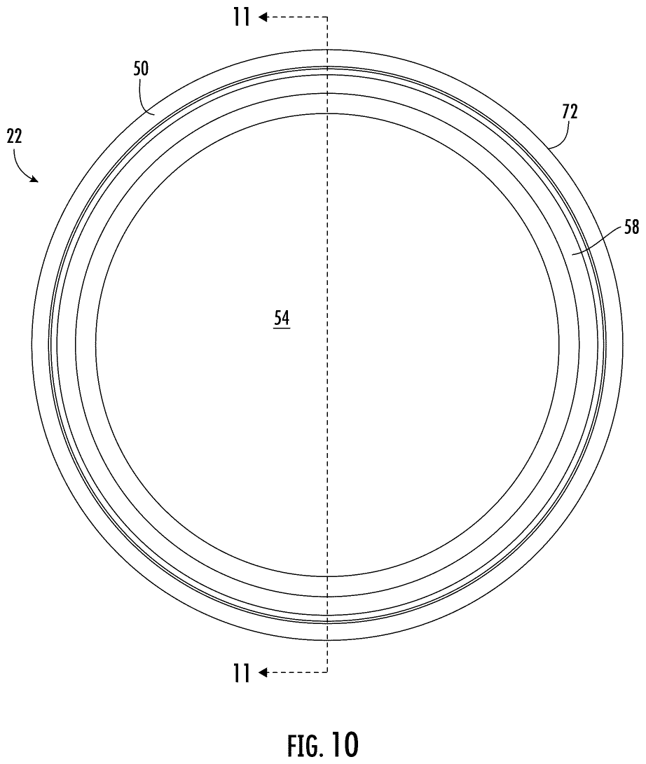

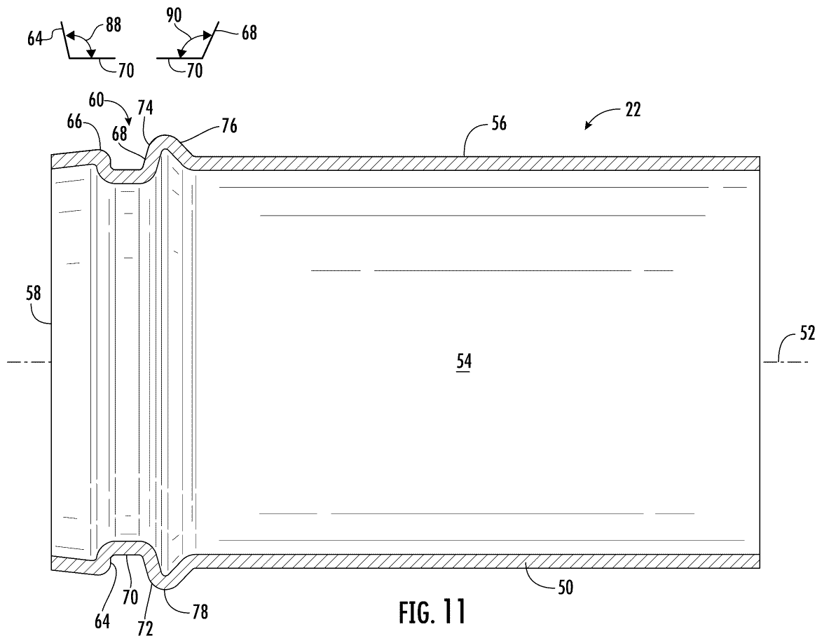

FIGS. 2-11 show an example pipe element 22. The pipe element 22 may be made of any conventional piping material, or other suitable materials, including malleable materials such as ferrous and nonferrous metals and polymers. Optionally, the pipe may be made of stainless steel. Optionally, pipe element 22 may be a thin wall pipe as understood in the industry, e.g., pipe that has a thinner wall than standard weight, Schedule 40 pipe, such as Schedule 10 pipe (as of the time of filing). The pipe element 22 comprises a sidewall 50 surrounding a longitudinal axis 52 and defining a bore 54 (see FIGS. 10 and 11). The longitudinal axis 52 is a central axis of the pipe element 22. The features of the sidewall 50, including the groove and bead described herein may be understood with reference to a cross-sectional plane including the longitudinal axis 52. The sidewall 50 has an outer surface 56. As used herein, the outer surface 56 refers to the outward-facing surface of the sidewall 50 and includes all portions of the outward-facing surface regardless of the local geometry. The outer surface 56 includes surfaces within the groove, surfaces of the bead, surfaces of the tubular portion, and any other outward-facing surfaces of the sidewall 50. For example, the floor surface and side surfaces of the groove are portions of the outer surface 56, even though these surfaces may be positioned at a smaller radius than other portions of the outer surface 56. Similarly, the summit of the bead is a portion of the outer surface 56, even though the summit may be positioned at a larger radius than other portions of the outer surface 56. Radii of features of the outer surface 56 described herein are measured from the longitudinal axis 52.

As shown in FIGS. 3-9, the sidewall 50 comprises an endform 80 which is a formed end portion of the pipe element 22. A tubular portion 82 of the sidewall 50 is connected to the endform 80. The tubular portion 82 may be contiguous with the endform 80. The endform 80 may extend from an end 58 of the pipe element 22 to the tubular portion 82. The endform 80 comprises a groove 60 defined by the outer surface 56 and extending circumferentially around the bore 54 (shown in FIGS. 10 and 11). The groove 60 is positioned proximate to the end 58 of the pipe element 22. As used herein to describe a location relative to an end of a pipe element, the term “proximate” means that said location is closer to the stated end than to the opposing end of the pipe element. Optionally, the term “proximate” can further indicate that said location is closer to the stated end than to a transverse plane that is perpendicular to a longitudinal axis of the pipe element and equidistant from the opposing ends of the pipe element. Similarly, the term “distant” as used herein to describe a location relative to an end of the pipe element 22 that is closer to the opposite end than the stated end.

The groove 60 comprises a first groove side surface 64 terminating at a first end 65. As described herein, in some aspects, the first end 65 may be a summit 66. The first groove side surface 64 may include transitions at either or both of the ends of the surface 64. The first groove side surface 64 may be planar, concave, convex, or combinations thereof. For example, the first groove side surface 64 may have an S-shaped profile in a cross-sectional plane including the longitudinal axis 52. The groove 60 comprises a second groove side surface 68 facing the first groove side surface 64 and in spaced apart relation from the first groove side surface 64. The first groove side surface 64 is positioned between the end 58 of the pipe element 22 and the second groove side surface 68. The second groove side surface 68 may include transitions at either or both of the ends of the surface 68. The second groove side surface 68 may be planar, concave, convex, or combinations thereof. A floor surface 70 of the groove 60 is contiguous with the first groove side surface 64 and the second groove side surface 68. The second groove side surface 68 extends from the floor surface 70 to an upper end 69. The floor surface 70 has a width extending parallel or substantially parallel to the longitudinal axis 52. The floor surface 70 may be oriented parallel or substantially parallel (for example within 5° of parallel) to the longitudinal axis 52. A radius 85 of the floor surface 70 measured from the longitudinal axis 52 may be less than any other radius measured from the longitudinal axis 52 to any part of the outer surface 56 of the endform 80. The radius 85 of the floor surface 70 measured from the longitudinal axis 52 may be less than a minimum radius 103 of the outer surface 56 of the tubular portion 82 measured from the longitudinal axis 52. The first groove side surface 64 is oriented at a first groove side angle 88 relative to the floor surface 70. The second groove side surface 68 is oriented at a second groove side angle 90 relative to the floor surface 70. When the first groove side surface 64 and/or the second groove side surface 68 is non-planar, the first groove side angle 88 and/or the second groove side angle 90 may be measured relative to a line extending between the endpoints of the respective surface in a cross-sectional plane including the longitudinal axis 52. Optionally, where there is a transition between surfaces, an endpoint of one of the surfaces may be taken as the midpoint of the transition between the surfaces. For example, if there is a transition (for example, a fillet) between the floor surface 70 and the first groove side surface 64, an endpoint of the first groove side surface 64 is the midpoint of the transition between the floor surface 70 and the first groove side surface 64. The second groove side angle 90 may be greater than the first groove side angle 88. The first groove side angle 88 may be an obtuse angle. The second groove side angle 90 may be an obtuse angle. The first groove side angle 88 and the second groove side angle 90 may each be from about 90° (for example, within 5° of 90°) to about 120° (for example, within 5° of 120°). Optionally, the first groove side angle 88 may be from 90° to 100° Optionally, the second groove side angle 90 may be from 100° to 110°. Thus, in some exemplary configurations, the first groove side angle 88 is from 90° to 100°, and the second groove side angle 90 is from 100° to 110°, with the second groove side angle 90 being greater than the first groove side angle 88.

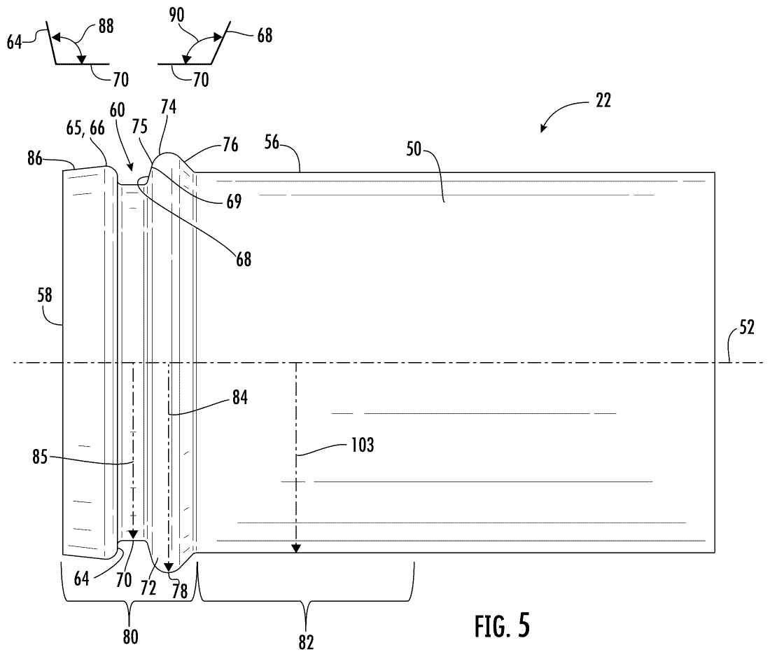

As shown in FIGS. 5-9, the endform 80 comprises a bead 72 defined by the outer surface 56. The bead 72 extends circumferentially around the bore 54 (shown in FIGS. 10 and 11). The bead 72 may be adjacent or contiguous with the groove 60. The location of bead 72 relative to groove 60 may be determined such that contact between the bead 72 and coupling 20, 20′ promotes alignment of arcuate projection 94 with groove 60 as described herein. Groove 60 is positioned between the end 58 of the pipe element 22 and the bead 72. The bead 72 comprises a first bead side surface 74 which transitions to a summit 78. The first bead side surface 74 is positioned between the summit 78 and the second groove side surface 68. The first bead side surface 74 may be contiguous with the second groove side surface 68 and may extend from the second groove side surface 68 to the summit 78. The first bead side surface 74 comprises a base end 75. The base end 75 of the first bead side surface 74 is closer to the floor surface 70 of the groove 60 than to the summit 78. The upper end 69 of the second groove side surface 68 and the base end 75 of the first bead side surface 74 may define a transition between the second groove side surface 68 and the first bead side surface 74. The transition may be a point of inflection where the curvature of the outer surface 56 changes direction. In some aspects, the upper end 69 of the second groove side surface 68 and the base end 75 of the first bead side surface 74 may be coincident, such that the transition is a distinct boundary between the second groove side surface 68 and the first bead side surface 74. In some aspects, the transition may comprise a radiused transition region connecting the upper end 69 of the second groove side surface 68 and the base end 75 of the first bead side surface 74. The second groove side surface 68 and the first bead side surface 74 may be oriented at the same or substantially the same angle relative to the floor surface 70. In some aspects, the second groove side surface 68 and the first bead side surface 74 may form a continuous or substantially continuous surface extending from the floor surface 70 to the summit 78.

A radius 84 of the summit 78 measured from the longitudinal axis 52 is a maximum radius of the outer surface 56 of a portion of the sidewall 50 between the summit 78 and the end 58 of pipe element 22. The radius 84 of the summit 78 measured from the longitudinal axis 52 may be greater than any other radius measured from the longitudinal axis 52 to any part of the outer surface 56 of the endform 80. The radius 84 of the summit 78 measured from the longitudinal axis 52 may be greater than a maximum radius 140 of the tubular portion 82 measured from the longitudinal axis 52.

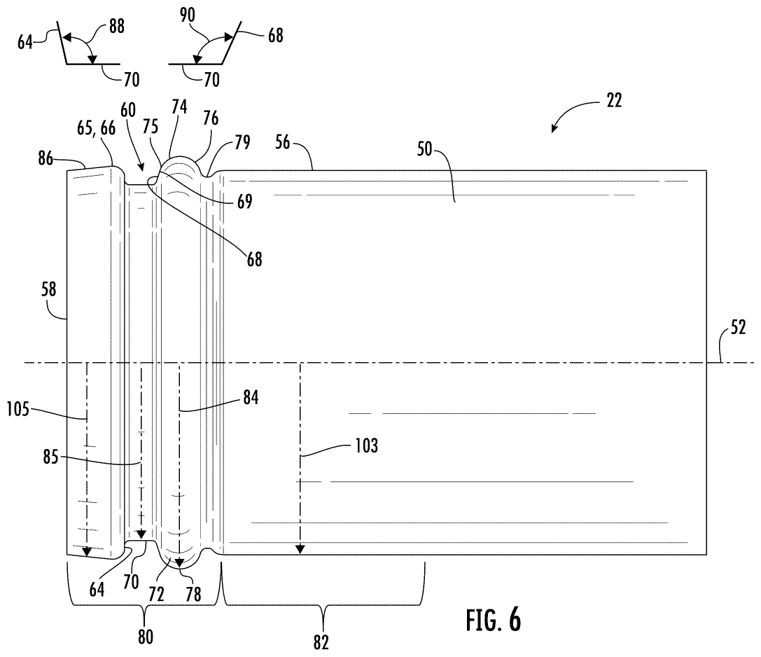

The bead 72 may further comprise a second bead side surface 76 extending from the summit 78 toward the tubular portion 82. The summit 78 is positioned between the first bead side surface 74 and the second bead side surface 76. The second bead side surface 76 has a larger radius measured from the longitudinal axis 52 at a point closer to the summit 78 than at a point farther from the summit 78. The tubular portion 82 may be contiguous with the second bead side surface 76. Optionally, as shown in FIG. 6, the endform 80 may comprise an indent 79 defined by the outer surface 56 which may extend circumferentially around the bore 54. The indent 79 may be contiguous with the second bead side surface 76. The indent 79 may be contiguous with the tubular portion 82. Optionally, the second bead side surface 76 may extend from the summit 78 to the indent 79. The presence or absence of indent 79 may be related to the method of manufacture of endform 80, and endforms 80 being formed by roll-forming may comprise indent 79. Endforms 80 may also be manufactured by other methods, such as casting, machining, or cold-working, and endforms 80 manufactured by these other methods may not include the indent 79, or optionally may include the indent 79. The indent 79 may be a tooling mark. The indent 79 may also provide evidence or guidance for proper installation of the pipe element relative to the coupling 20, 20′. Optionally, the indent 79 may comprise indicia that may identify the model number and/or source of the product. These other methods of manufacture of endforms 80, for instance casting, machining, and some types of cold working, may permit variations in the form of endform 80 that do not depart from the concepts herein disclosed; for instance these other methods may permit bead 72 or summit 78 to discontinuously extend around the bore 54.

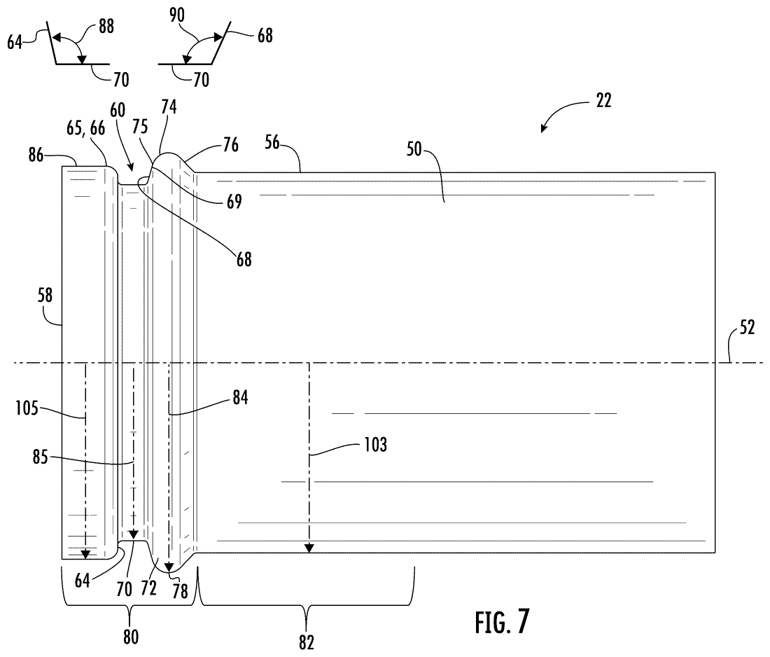

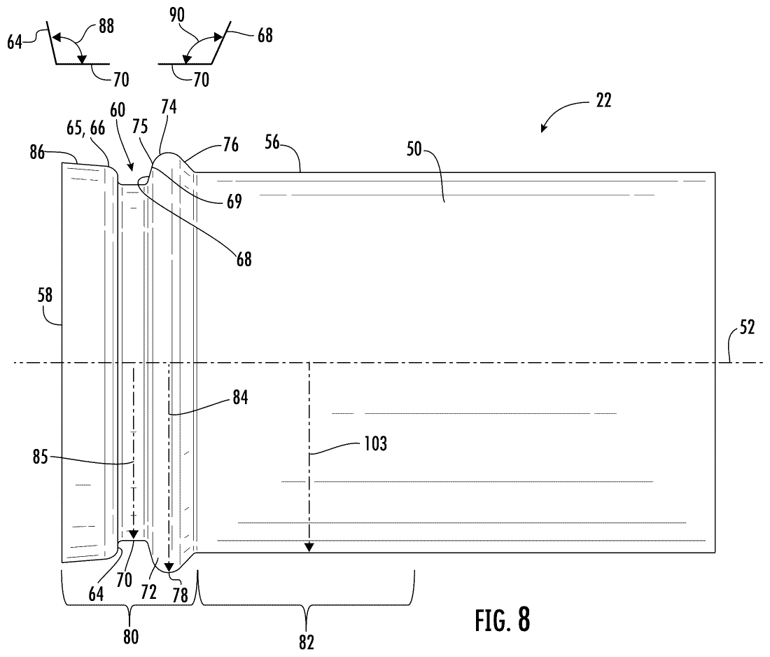

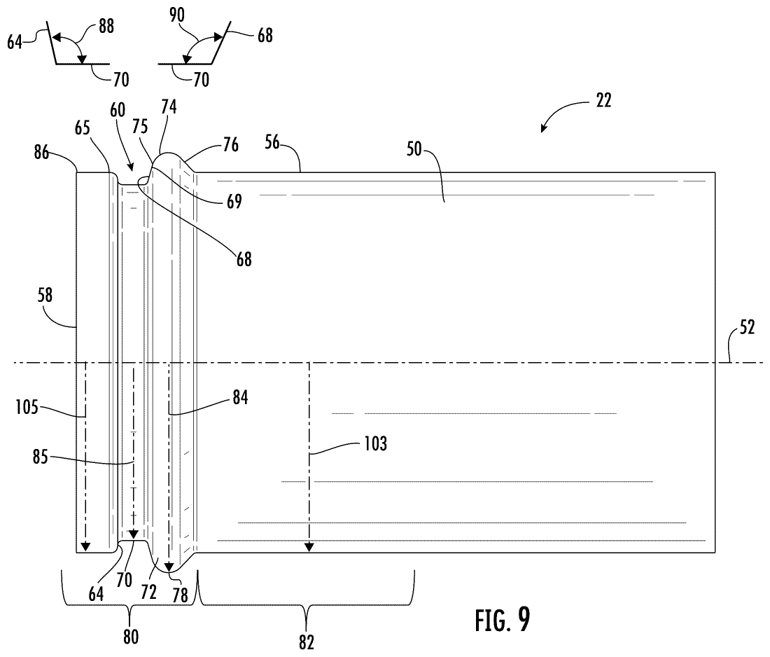

Optionally, in the example pipe element shown in FIGS. 3-9, the endform 80 further comprises a sealing surface 86 positioned between the first groove side surface 64 and the end 58 of the pipe element 22. The sealing surface 86 may extend from the first groove side surface 64 to the end 58 of the pipe element 22. Optionally, the sealing surface 86 may be contiguous with the first groove side surface 64. The sealing surface 86 may extend from the first end 65 of the first groove side surface 64 to the end 58 of the pipe element 22. As shown in FIGS. 7 and 9, the sealing surface 86 may be cylindrical or substantially cylindrical, and may have a radius 105 that is greater than the radius 85 of the floor surface 70 and less than the radius 84 of summit 78. Optionally, as shown in FIG. 9, the radius 105 of the cylindrical or substantially cylindrical surface 86 may be the same or substantially the same as the radius 103 of the tubular portion. Alternatively, as shown in FIG. 7, the radius 105 of the cylindrical or substantially cylindrical surface 86 may be greater than the radius 103 of the tubular portion. Optionally, as shown in FIG. 5, the sealing surface 86 may be frustoconical such that a radius of the sealing surface 86 measured from the longitudinal axis 52 at a first point may be less than a radius of the sealing surface 86 measured from the longitudinal axis 52 at a second point, wherein the first point is closer to the end 58 of the pipe element 22 than the second point to the end 58 of the pipe element 22. As shown in FIG. 5, where the sealing surface 86 is frustoconical such that the sealing surface 86 tapers inwardly from the first groove side surface 64 towards the end 58 of the pipe element 22, the first end 65 of the first groove side surface 64 may be summit 66. The sealing surface 86 may be positioned between the summit 66 and the end 58 of the pipe element 22. The sealing surface 86 may extend from the summit 66 to the end 58 of the pipe element 22. Optionally, as shown in FIG. 8, a radius of the sealing surface 86 measured from the longitudinal axis 52 at a first point may be larger than a radius of the sealing surface 86 measured from the longitudinal axis 52 at a second point, wherein the first point is closer to the end 58 of the pipe element 22 than the second point to the end 58 of the pipe element 22.

The geometry of the sealing surface 86 may be influenced by the roll forming process used to form the endform 80 and by the tolerances of the pipe element 22. The roll forming process may be configured to position the floor surface 70 of the groove 60 at a predetermined radius to interact appropriately with the arcuate projection of the coupling 20, 20′. When the pipe element 22 has a diameter on the smaller side of the tolerance range, the roll forming process may drive the floor surface 70 to the predetermined radius, and there may be more clearance between the pipe element 22 and the roller surface that forms the end 58 of the pipe element 22. In this case, the sealing surface 86 may flare or trumpet outwardly such that the sealing surface 86 has a larger radius at a point closer to the end 58 than at a point further from the end 58. When the pipe element 22 has a diameter on the larger side of the tolerance range, the sealing surface 86 may taper inwardly such that the sealing surface 86 has a smaller radius at a point closer to the end 58 than at a point further from the end 58. When the pipe element 22 has a diameter in the middle of the tolerance range, the sealing surface 86 may be cylindrical or substantially cylindrical. In some embodiments, the geometry of the sealing surface may have been selected for other practical or performance considerations; for instance, a frustoconical sealing surface 86 may promote easier installations into coupling 20, 20′ as the frustoconical sealing surface may act as a “lead in” that guides the pipe element 22 into coupling 20, 20′. The coupling 20, 20′ and gasket may be configured to seal against the sealing surface 86 regardless of whether the sealing surface 86 is frustoconical tapering inwardly, frustoconical tapering outwardly, cylindrical, or any combination thereof.

### Grooved Couplings

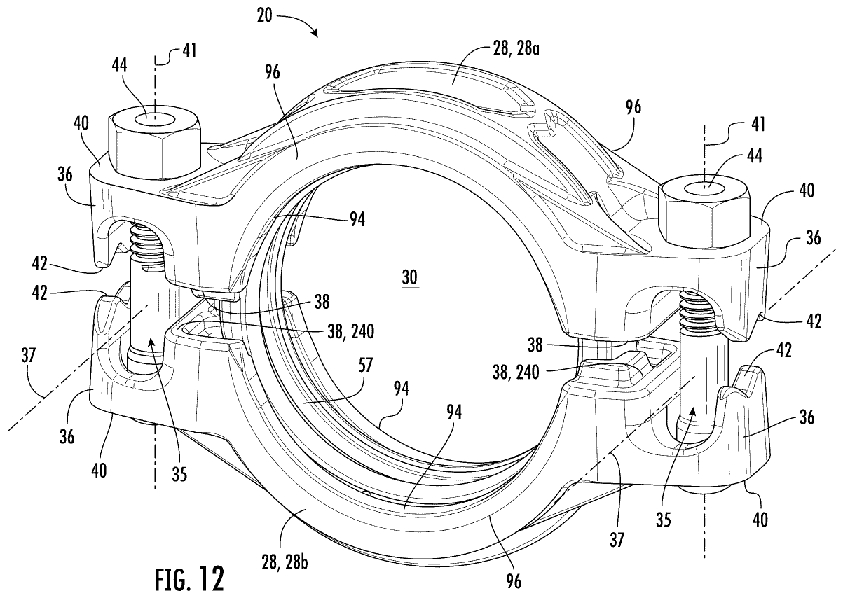

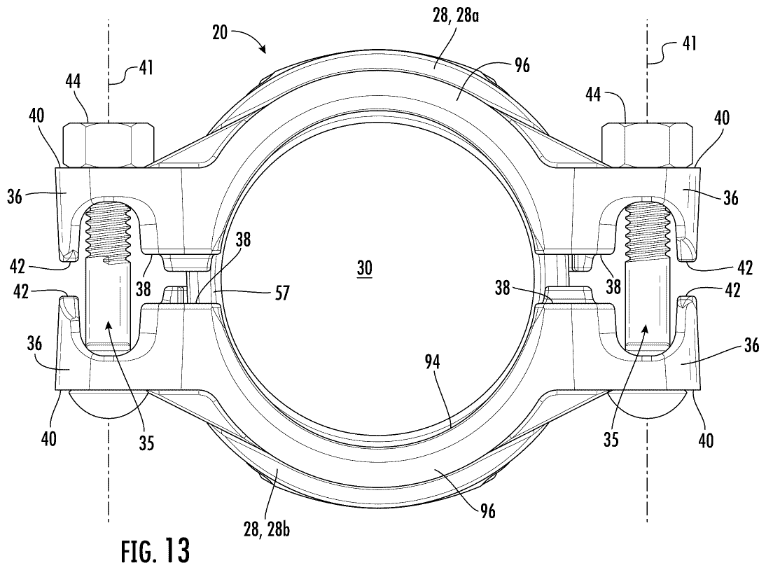

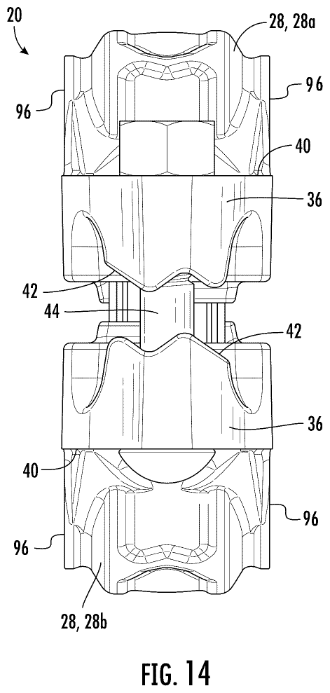

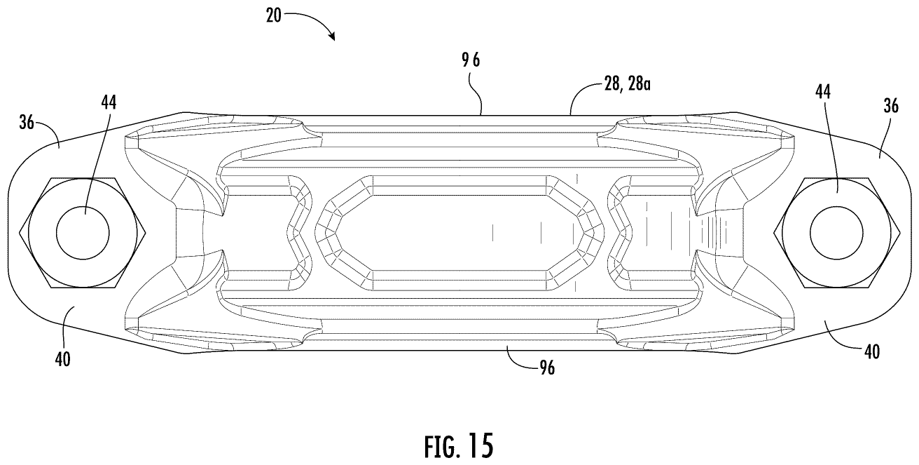

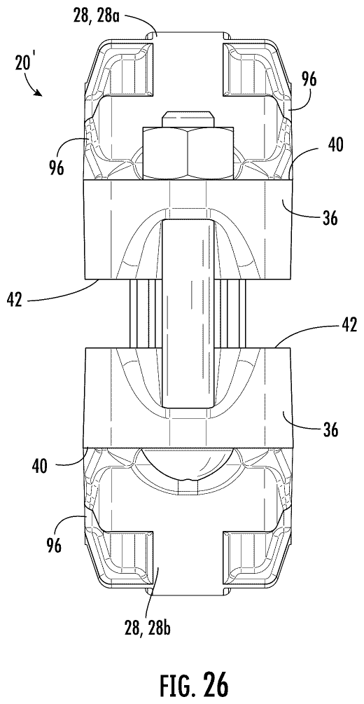

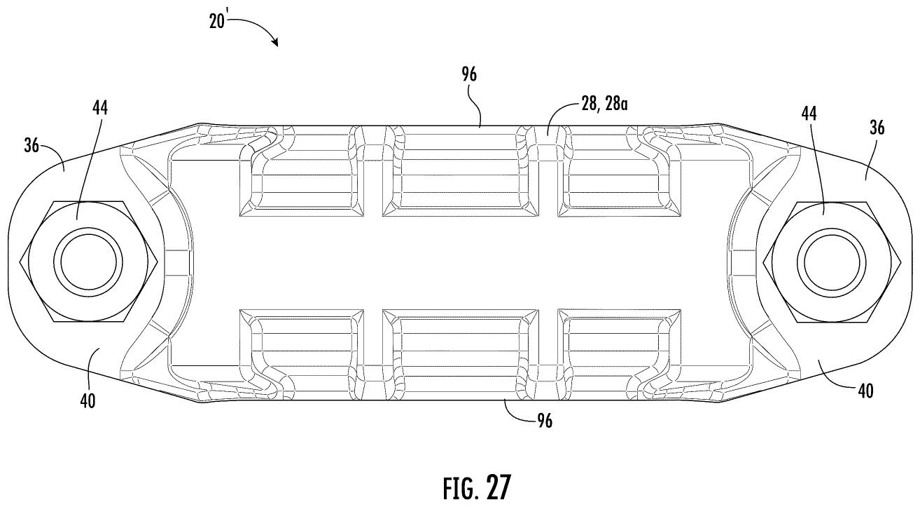

FIGS. 12-15 and 24-27 show an example grooved coupling 20, 20′. Couplings 20, 20′ according to the disclosure may take various forms. It is understood that the details of the coupling 20, 20′ described herein, including the arcuate projections (described herein) and the wedging effect of the arcuate projections in the groove (described herein), may be applied to various coupling configurations. FIGS. 12-15 show a first example coupling 20 according to the disclosure, and FIGS. 24-27 show a second example coupling 20′ according to the disclosure. The following description applies generally to couplings according to the disclosure (including coupling 20 and coupling 20′) unless otherwise indicated.

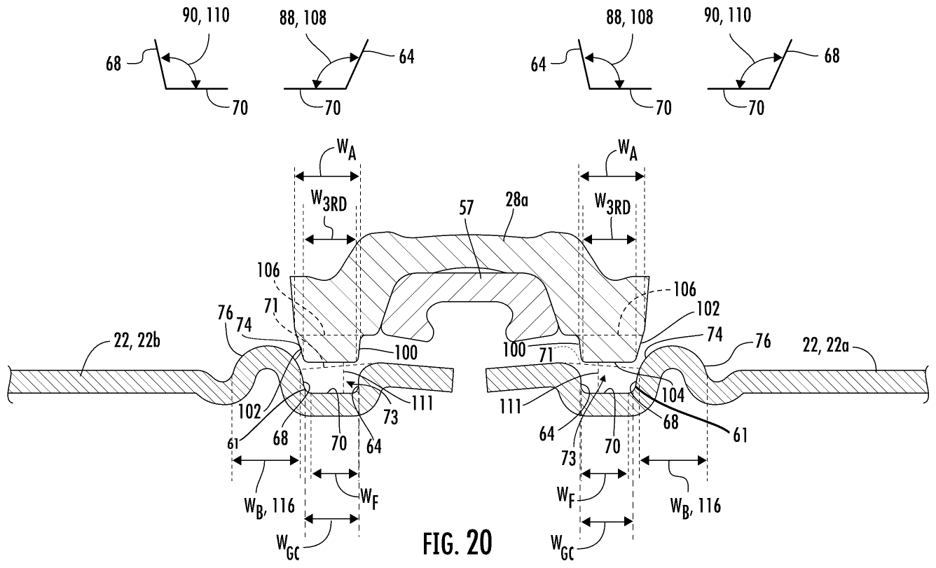

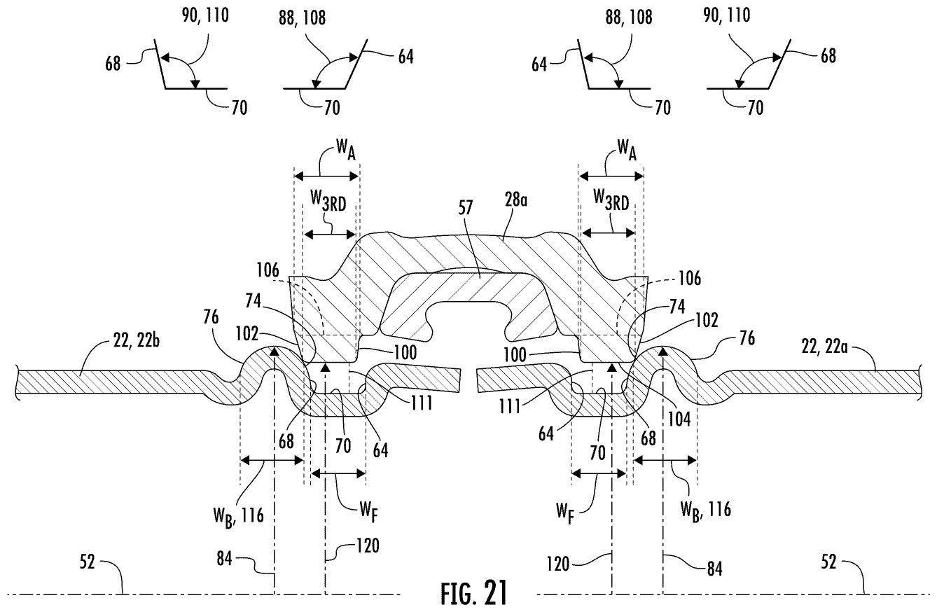

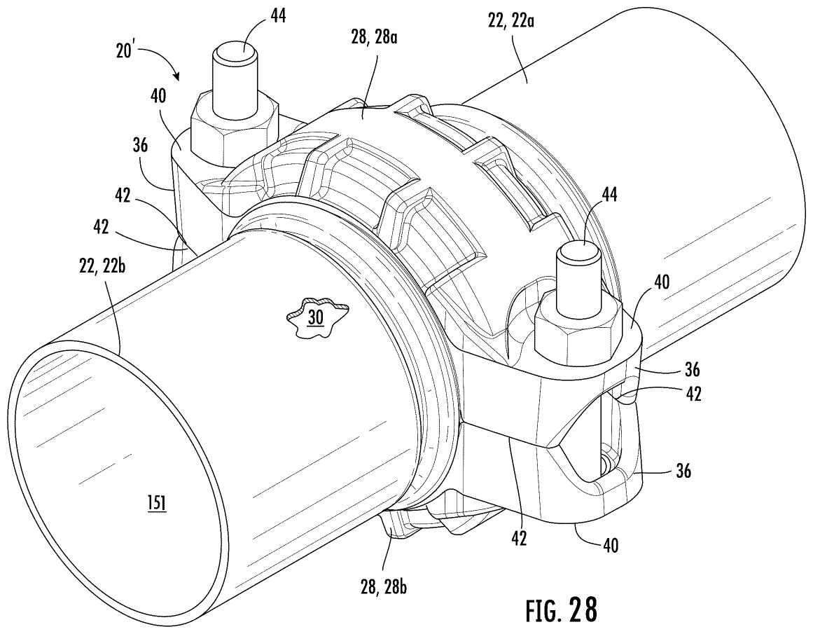

As shown in FIGS. 12-15 and 24-27, the attachment members 36 of the coupling 20, 20′ comprise lugs 40, wherein respective lugs 40 may be attached via fasteners 44. At least one fastener 44 is an adjustably tightenable fastener, such as a bolt and nut. Each lug 40 comprises an inner bolt pad surface 38. Optionally, each lug 40 may comprise a stop surface 42. As shown in FIGS. 20 and 21, the stop surface 42 of coupling 20′ may be contiguous with the inner bolt pad surface 38. Alternatively, as shown in FIGS. 9 and 10, each lug 40 of coupling 20 may define an opening 35 surrounding a first axis 37 oriented perpendicularly to a longitudinal axis 41 of the respective fastener 44 and extending through the lug 40 such that the stop surface 42 is spaced from the inner bolt pad surface 38. The bending stiffness may be tuned to a desired value by the sizing of the opening 35. As shown in FIGS. 1 and 28, in the tightened condition, the stop surfaces 42 of coupling 20, 20′ on respective ends of the segments 28a, 28b may engage each other. As shown in FIG. 28, stop surfaces 42 of coupling 20′ are shown as flat pads; however, the disclosure is not so limited and the stop surfaces may take the form of slanted pads, tongue and recess, and other known interfaces. Optionally, the coupling 20′ may be in the tightened condition when the fasteners are tightened a predetermined amount. In the tightened condition, stop surfaces 42 may be separated by a gap. The gap may account for practical tolerance variations of the pipe element 22 and couplings 20 and 20′ as disclosed herein.

As shown in FIG. 12, the inner bolt pad surface 38 of coupling 20 may comprise an action surface 240. The action surface 240 may be positioned between the central space 30 and stop surface 42. The fastener 44 may be positioned between the action surface 240 and the stop surface 42. The action surface 240 and the stop surface 42 may be oriented transversely to a longitudinal axis 41 of the fastener 44. Optionally, the action surface 240 and/or stop surface 42 may be oriented perpendicularly or substantially perpendicularly (for example within 10° of perpendicular) to the longitudinal axis 41 of the fastener 44. The geometry of respective stop surfaces 42 may be complementary. For example, the stop surfaces may define at least one receiving space and shape such that the shape of a stop surface 42 may insert into the receiving space of a respective stop surface 42 and/or vice versa to interlock respective stop surfaces 42.

To account for tolerances for the pipe surface, including, for example, pipe diameter, groove depth, groove width, and groove location in the pipe element and the tolerance range of the interfacing surface of the coupling, the coupling 20 may be adapted for different tightened configurations, including to address practical tolerance ranges. A person of ordinary skill in the art would understand the arcuate surfaces of the segments may be imperfect and references to the diameter or radius of elements, such as the arcuate surfaces, may be represented by a best fit curve. In exemplary configurations, the lugs 40 are adapted, upon tightening of the adjustable fastener 44, to assume either a first configuration, wherein the action surfaces 240 are in contact with one another and the stop surfaces 42 are in contact with one another, or a second configuration, wherein the stop surfaces 42 are in contact with one another, there being a gap between the action surfaces 240. In further exemplary configurations, the stop surfaces 42 on the lugs 40 engage one another to visually indicate that a proper installation of the coupling 20 has been achieved.

Optionally, upon adjusting the fastener 44 to draw the first segment 28a and the second segment 28b toward one another, engagement between the stop surfaces 42 on the lugs 40 may arrest rotation of the segments 28a, 28b relative to one another, wherein the rotation of the segments 28a, 28b may be caused by friction associated with the rotation of the fasteners, the geometry of the action surfaces, and/or the geometry of the stop surfaces.

### Formation of Joints

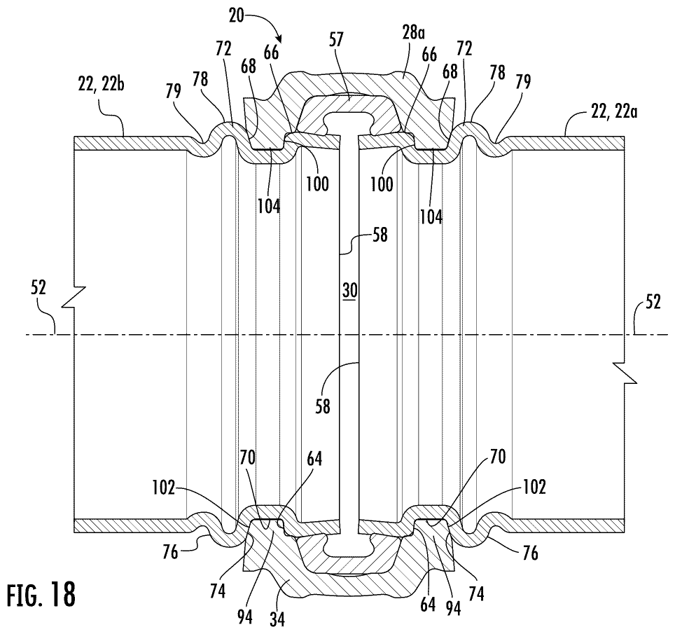

The coupling 20, 20′ comprises a ring seal 57 configured to be captured and compressed between the segment 28a, 28b and the pipe elements 22a, 22b (see FIGS. 18-23) when the segments 28a, 28b are drawn toward one another and into engagement with the pipe elements 22a, 22b to form a fluid tight joint. Optionally, the ring seal 57 does not comprise a tongue or center leg.

In exemplary configurations, as shown in FIGS. 12-14, 16, 17,, and 20-21, the plurality of segments 28a, 28b are attached to one another end to end in a preassembled state. In the preassembled state, the plurality of segments 28a, 28b are supported in spaced relation while attached to one another to allow insertion of the pipe element 22 into the central space 30. The ring seal 57 may support the plurality of segments 28a, 28b in the preassembled state. One or more fasteners 44 may hold the segments 28a, 28b together and against the ring seal 57, which has sufficient stiffness to support the segments in the preassembled state, although other methods for maintaining the segments in a preassembled state, such as spacers, and spring-like elements, may be employed.

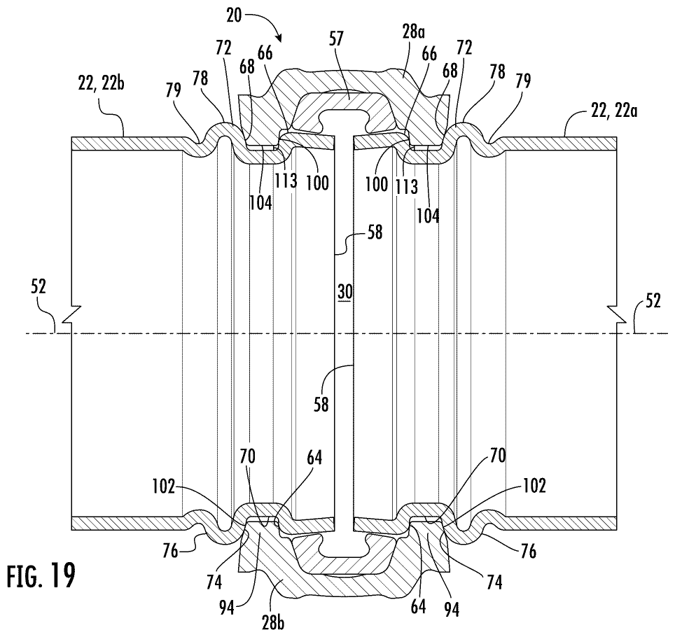

As shown in FIGS. 18 and 19, an arcuate projection 94 is positioned on at least one side 96 (e.g., both sides) of each of the segments 28a, 28b and is configured to engage with the groove 60. Thus, the coupling 20, 20′ has a plurality of arcuate projections 94 (e.g., with two arcuate projections on each segment of the coupling). In the following description, even when only a single arcuate projection is discussed, it is understood that the features related to that arcuate projection are applicable to other arcuate projections (optionally, every other arcuate projection) of the coupling. Each arcuate projection 94 projects radially inwardly from the respective side of each segment 28a, 28b. The arcuate projection comprises a first mating surface 100. The first mating surface 100 extends radially inwardly towards the central space 30 from the side of the segment 28a, 28b. The first mating surface 100 is configured to engage the first groove side surface 64. The arcuate projection comprises a second mating surface 102. The second mating surface 102 extends radially inwardly towards the central space 30 from the side of the segment 28a, 28b. The second mating surface 102 is configured to engage the second groove side surface 68. The second mating surface 102 faces away from the first mating surface 100. The arcuate projection 94 comprises a third mating surface 104 positioned between and contiguous with the first mating surface 100 and the second mating surface 102. The third mating surface 104 extends along the length of the arcuate projection 94. The third mating surface 104 faces the central space 30. The first mating surface 100 may taper towards the second mating surface 102 and the second mating surface 102 may taper towards the first mating surface 100 such that a width W_{A} of the base 106 of the arcuate projection 94 is wider than a width W_{3RD} of the third mating surface 104 (shown in FIGS. 20 and 21). Except where otherwise indicated, it is contemplated that a “taper” or a “tapered” portion/surface can refer to any gradual decrease or narrowing in width or diameter, whether at a constant or variable rate. Optionally, the “taper” or “tapered” portion/surface can be a consistent/constant taper moving along a given length (e.g., a taper at a fixed angle). The width W_{3RD} of the third mating surface 104 extends perpendicularly or substantially perpendicularly (for example within 5° of perpendicular) to the length of the arcuate projection.

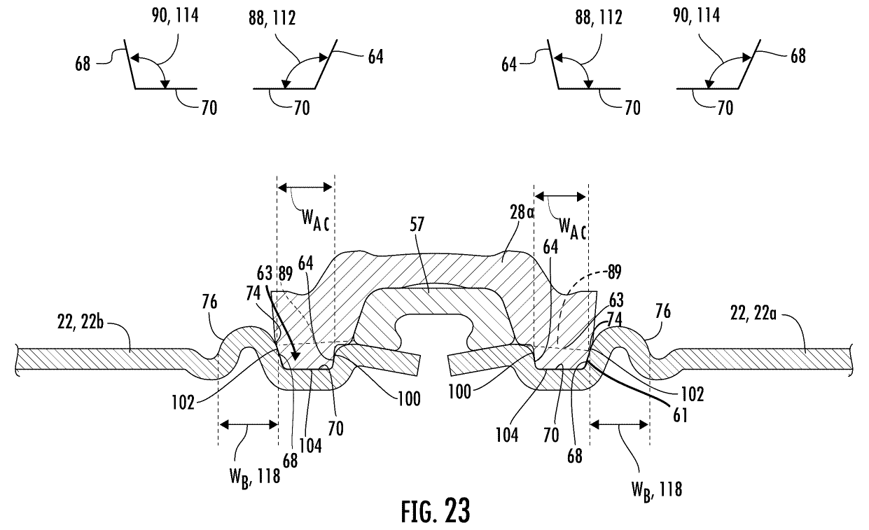

As shown in FIGS. 20-23, the plurality of segments 28a, 28b are configured to be drawn towards one another from an initial condition (shown in FIG. 20) (optionally a preassembled condition (shown in FIGS. 12-14 and 24-26)) to a tightened condition (shown in FIGS. 1, 18, 19, 23, and 28). As shown in FIGS. 20 and 21, in the initial condition, the third mating surface 104 is spaced from the floor surface 70 of the groove 60 by a first distance 111. As shown in Figures18, 19, and 23, in the tightened condition, the third mating surface 104 engages the floor surface 70 of the groove 60 (FIGS. 18 and 23) or the third mating surface 104 is spaced from the floor surface 70 of the groove 60 by a second distance 113 (FIG. 19). The second distance 113 is less than the first distance 111 and may be zero. In the tightened condition, the combination coupling 20, 20′ and pipe element 22 may have sufficient axial rigidity that when an assembled joint is pressurized to its rated pressure (which may be from about 100 psi to about 750 psi, or more particularly from about 250 psi to about 500 psi) the pipe elements do not axially pull out of the joint more than a negligible amount (a negligible amount being not more than approximately the amount which is due to the inherent compliance of the components as opposed to movement of one component relative to another due to a lack of forceful contact or mechanical interlock between the components). Optionally, as shown in FIGS. 12-14 and 24-26, in the initial condition (which may be a preassembled condition), the stop surfaces 42 may be in spaced relation. In the tightened condition, shown in FIGS. 1 and 28, the stop surfaces 42 on respective ends of the segments 28a, 28b may engage each other.

As shown in FIGS. 20-23, as the segments 28a, 28b are drawn together from the initial condition (shown in FIG. 20) to the tightened condition (shown in FIGS. 18, 19, and 23), each arcuate projection 94 of the coupling 20, 20′ wedges into the groove 60. The geometry of the arcuate projection 94 of the coupling 20, 20′ and the geometry of the groove 60 of the pipe element 20 promote the wedging of the arcuate projection 94 in the groove 60.

In an example aspect, with reference to FIG. 23, in the tightened condition and in a cross-sectional plane including the longitudinal axis 52, at least a portion of the arcuate projection 94 has a width W_{AC} (extending parallel or substantially parallel (for example within 5° of parallel) to the longitudinal axis 52) that causes the arcuate projection 94 to forcefully contact the first groove side surface 64 and second groove side surface 68 and wedge into the groove 60. In the example shown in FIGS. 20-23, forceful contact between the arcuate projection 94 and the groove 60 occurs at contact point 61. To cause the wedging, the width W_{AC} of the portion of the arcuate projection 94 in forceful contact with the first and second groove side surfaces 64, 68 (shown in FIG. 23), is wider than a width W_{GC} (extending parallel or substantially parallel (for example within 5° of parallel) to the longitudinal axis 52) of the groove 60 at the same or substantially same location as the point of contact 61 when the coupling 20, 20′ is in the initial condition (shown in FIG. 20).

In an example aspect, in the tightened condition and in a cross-sectional plane including the longitudinal axis 52, a cross-sectional area 63 of the arcuate projection 94 (shown in FIG. 23) is defined by the first mating surface 100, second mating surface 102, and a plane 89 intersecting the first end 65 of the first groove side surface 64 and the upper end 69 of the second groove side surface 68. In the initial condition and in a cross-sectional plane including the longitudinal axis 52, a cross-sectional area 73 of the groove 60 (shown in FIG. 20) is defined by the first groove side surface 64, the second groove side surface 68, and a plane 71 intersecting the first end 65 of the first groove side surface 64 and the upper end 69 of the second groove side surface 68. Cross-sectional area 63 of the arcuate projection 94 may be greater than the cross-sectional area 73 of the groove such that the arcuate projection 94 wedges into the groove 60.

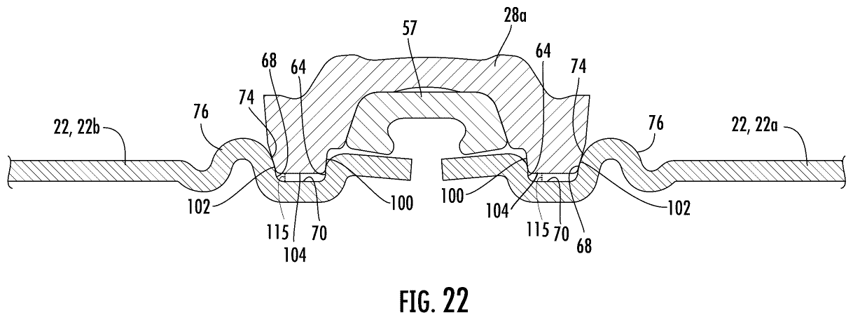

In an example aspect, as shown in FIG. 20, to cause the wedging of the arcuate projection 94 in the groove 60, the width W_{3RD} of the third mating surface 104 may be greater than a width W_{F} of the floor surface 70 of the groove 60 in the pipe element 22. When the width W_{3RD} of the third mating surface 104 is greater than a width W_{F} of the floor surface 70 of the groove 60 in the pipe element 22, the first mating surface 100 and the second mating surface 102 engage the first groove side surface 64 and the second groove side surface 68, respectively, before the segments 28a, 28b reach the tightened condition. In an intermediate condition before the segments reach the tightened condition, the first mating surface 100 and the second mating surface 102 engage the groove side surface 64, 68, and the third mating surface 104 is spaced from the floor surface 70 of the groove 60 by a third distance 115 (shown in FIG. 22). The third distance 115 is greater than the second distance 113.

Projections or keys which have a third mating surface having an axial width smaller than the axial width of the floor of the groove, and generally have a cross-sectional area smaller than the cross-sectional area of the groove, may undesirably allow some slippage of the segments of the coupling relative to the pipe element before the sidewall(s) of the key contacts the sidewall(s) of the groove. Unlike the projections which have a third mating surface having an axial width smaller than the axial width of the floor of the groove (and smaller cross-sectional area), the arcuate projection 94 is configured to axially fill the groove 60, thereby reducing or avoiding unwanted slippage.

Optionally, with reference to FIGS. 20 and 23, the groove 60 flexes open and the third mating surface 104 may approach the floor surface 70 of the groove 60 such that:
in the initial condition, the first groove side angle 88 is a first angle 108 and the second groove side angle 90 is a second angle 110;
in the tightened condition, the first groove side angle 88 is a third angle 112 and the second groove side angle 90 is a fourth angle 114;
the third angle 112 is greater than the first angle 108 and fourth angle 114 is greater than the second angle 110; and
the second distance 113 between the third mating surface 104 and the floor surface 70 of the groove 60 is less than the first distance 111 (and may be zero) between the third mating surface 104 and the floor surface 70 of the groove 60.

In some aspects, the mating surfaces 100, 102, and/or 104 of the arcuate projection(s) 94 and/or the side surfaces 64 and/or 68 of the groove 60 may experience localized deformation, including surface deformation, as the arcuate projection 94 is wedged into the groove 60. It is expected that there will be varied combinations of flexing open of the groove 60 and localized deformation of the groove 60 as the arcuate projection 94 is wedged into the groove 60 across varying tolerances of groove 60 and arcuate projection 94.

Optionally, as the arcuate projection 94 wedges into the groove 60, the arcuate projection 94 may force the bead 72 to flex closed by pushing the first bead side surface 74 towards the second bead side surface 76 such that:
the bead 72 has a bead base width W_{B} extending parallel or substantially parallel (for example within 5° of parallel) to the longitudinal axis 52;
in the initial condition, the bead base width W_{B} is a first width 116;
in the tightened condition, the bead base width W_{B} is a second width 118; and
the second width 118 is less than the first width 116.

The geometry of the bead 72 may cause the bead 72 to act like a spring such that the base end of the first bead side surface 74 is biased towards the end 58 of the pipe element 22 along the longitudinal axis 52 thereby facilitating wedging of the arcuate projection 94. The resulting spring like action may reduce or eliminate stretching and/or damage to the pipe element.

The wedging action of the arcuate projection 94 and groove 60 promotes a more rigid joint. The coupling 20, 20′ promotes wedging by producing forceful contact between the arcuate projections 94 of the segments 28a, 28b and the first groove side surface 64 and the second groove side surface 68 of the groove 60 of the pipe element over a broad tolerance range of groove diameters and a broad tolerance range of diameters of the arcuate projection surfaces (corresponding to the diameters of the best fit curves of the arcuate surfaces) of the segments as measured from the center of the respective segment. FIGS. 18 and 19 show the segments 28a, 28b in a tightened condition after the adjustable fasteners 44 have been tightened at different points within the tolerance ranges of the circumferential grooves in the pipe elements and within the tolerance ranges of the arcuate surfaces of the coupling segments (i.e. between a first extreme where the pipe groove diameter is largest and the arcuate surface diameter is smallest and a second extreme where the pipe groove diameter is smallest and the arcuate surface diameter is largest). The configurations described in FIGS. 18 and 19 are illustrative of certain tolerance conditions, and the full range of tolerance conditions encountered in field applications is contemplated within the scope of the disclosed couplings and joints, including tolerance conditions in between those specifically illustrated or recited herein.

As shown in FIG. 18, in a tightened condition under a first tolerance that may be at or near the higher end point of the groove diameter tolerance range and at or near the lower end point of the arcuate projection surfaces diameter range, the first mating surface 100 and the second mating surface 102 of the arcuate projection 94 may wedge against (optionally, wedge open) the first groove side surface 64 and the second groove side surface 68 such that the third mating surface 104 of the arcuate projection 94 engages the floor surface 70 of the groove 60.

As shown in FIG. 19, in a tightened condition under a second tolerance that is at or near the lower end point of the groove diameter tolerance range and at or near the higher end point of the arcuate projection surfaces diameter range, the first mating surface 100 and the second mating surface 102 of the arcuate projection 94 may wedge against (optionally, wedge open) the first groove side surface 64 and the second groove side surface 68 such that the third mating surface 104 of the arcuate projection 94 is spaced from the floor surface 70 of the groove 60. Tightened conditions under tolerance ranges between the tolerance ranges shown in FIGS. 18 and 19 may result in less space between the third mating surface 104 of the arcuate projection 94 and the floor surface 70 of the groove 60 than the space shown in FIG. 19.

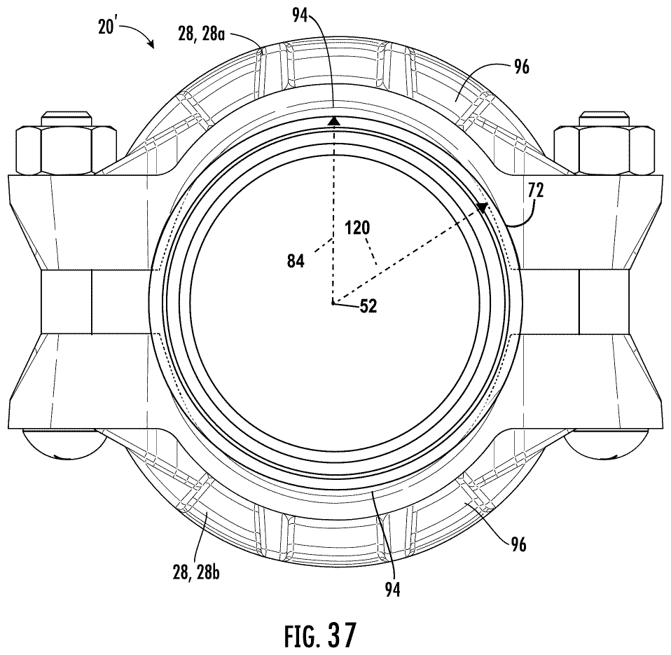

FIGS. 20 and 21 show, in detail, an exemplary cross-sectional geometry of the arcuate projections 94 and end 58 of each pipe element 22a, 22b initially upon insertion of the pipe elements 22a, 22b in the central space 30 when the coupling 20, 20′ is in the preassembled state. The geometry of the arcuate projection 94 and the endform 80 of the pipe element 22 may facilitate alignment and engagement of the arcuate projection 94 and respective groove 60. The geometry of the arcuate projection 94 and the endform 80 of the pipe element 22 facilitates alignment and engagement between a groove 60 and arcuate projection 94 of a coupling 20, 20′ that does not rely upon engagement between a tongue or center leg of the seal 57 with endform 80, and without requiring manual alignment of the arcuate projection and groove. As shown in FIG. 21, the bead 72 has a radius 84 that causes the pipe element 22 to engage the coupling 20, 20′ to prevent the pipe element 22 from moving farther into the central space 30 and to align the groove 60 of the pipe element with respect to the arcuate projection 94. As shown in FIG. 21, in a cross-sectional plane including the longitudinal axis 52, the radius 84 of the summit 78 may be greater than a linear distance 120 measured from the longitudinal axis 52 to at least a portion of the third mating surface 104 of the arcuate projection 94, the linear distance 120 extending along an axis parallel or substantially parallel (for example within 5° of parallel) to the radius 84 of the summit 78, when the coupling 20, 20′ is in the preassembled state such that the coupling 20, 20′ engages the second groove side surface 68 and/or the first bead side surface 74 and the pipe element 22 is prevented from moving farther into the central space 30. As shown in FIG. 37 (gasket 57 and certain details of pipe element 22 are not shown for clarity), because the segments 28 are offset from the longitudinal axis 52 in the preassembled state, the bead 72 may only contact a portion of the coupling 20, 20′ (coupling 20′ shown). In some embodiments, including as depicted in FIG. 21, the arcuate projection 94 (in this example, the second mating surface 102 of the arcuate projection 94) engages with bead 72. The geometry of the arcuate projection 94, including the second mating surface 102, and the geometry of the bead 72 and groove 60, including the second groove side surface 68 and/or the first bead side surface 74, may be designed to force the pipe element 22 to move axially outward from the central space 30 as the arcuate projection 94 slides radially inwardly towards the central space along the second groove side surface 68 and/or the first bead side surface 74 to align and facilitate the arcuate projection 94 being received within the groove 60.

In addition to the advantages provided by the groove and the bead independently, the combination of the groove 60 and bead 72 in the endform may increase the stiffness and rigidity of the pipe element in the region of the endform. The geometry of the groove 60 and bead 72 may provide increased resistance to deformation and bending forces (for example, in a manner similar to corrugations). In some aspects, the increased stiffness provided by the groove 60 and bead 72 may allow the use of thinner wall pipe while maintaining sufficient structural integrity at the joint. The bead 72, having a summit with a radius greater than other portions of the outer surface of the endform, may further contribute to the stiffness of the endform by providing additional material displacement away from the longitudinal axis.

As shown in FIG. 1, as the adjustable fasteners 44 are adjusted to draw the first and second segments 28a, 28b toward one another to the tightened condition, the stop surfaces 42 of the segments 28a, 28b may engage. At a certain point, engagement between the arcuate projections 94 and the circumferential grooves 60 of the pipe element 22 may prevent the segments 28a, 28b from drawing towards one another. At this point, the bending stiffness of the lugs 40 of coupling 20 is tuned such that further tightening of the adjustable fasteners 44 may allow the lugs 40 to bend toward one another respectively until the respective stop surfaces 42 engage (see FIG. 1). The geometry of the stop surfaces 42, their lengths, positions on the segments and orientation angles are coordinated with the arcuate projections 94 such that the projections wedge or lock up effectively within the circumferential grooves 60 of the pipe elements 22 when the stop surfaces 42 respectively engage, or nearly engage, in the tightened condition as depicted in FIG. 1. Thus, engagement between the stop surfaces 42 may serve as final visual confirmation that the coupling 20 has been properly installed and is in the tightened condition. The stop surfaces 42 may provide this visual confirmation over the entire tolerance range (from the lower end point of the tolerance range to the higher end point of the tolerance range) imposed on the circumferential grooves in the pipe elements.

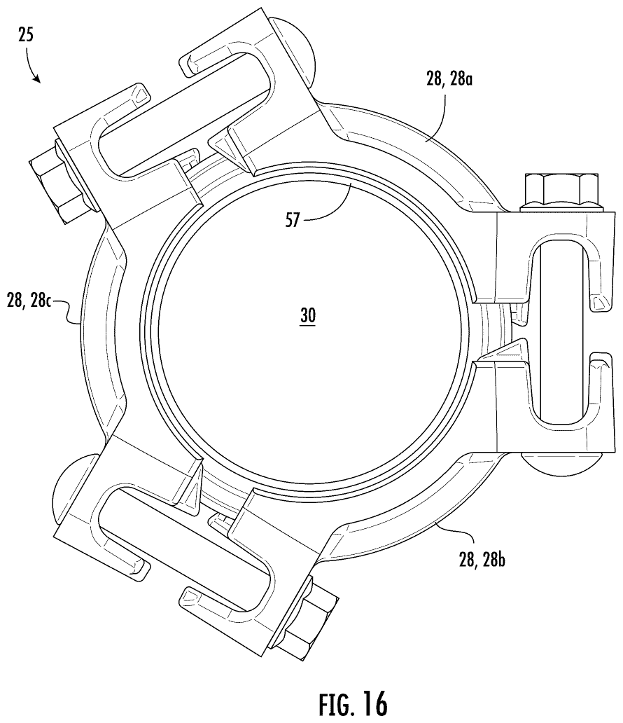

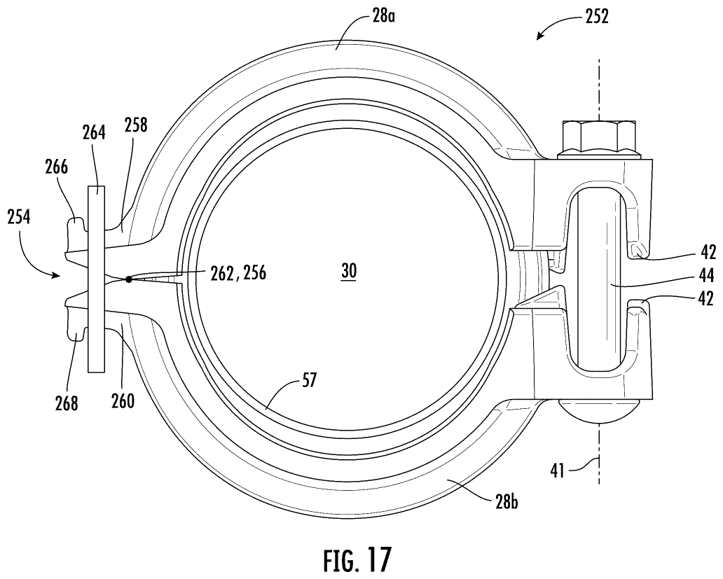

The details of the couplings 20 and 20′ described herein, particularly with respect to the arcuate projections 94 and the wedging effect of the arcuate projections 94 in the groove 60, may be applied to various forms of grooved couplings. In particular, the arcuate projections 94 and the wedging engagement described herein may be incorporated into couplings similar to couplings 20 and 20′ described herein, but which are not provided in a preassembled state and which are instead assembled about a pair of pipe elements 22. As another example, the arcuate projections 94 and the wedging engagement described herein may be incorporated into couplings having different segment configurations, attachment mechanisms, or other structural variations. For instance, FIGS. 16 and 17 provide example variations of grooved couplings to which the arcuate projection and wedging features described herein may be applied. FIG. 16 illustrates another example embodiment of a coupling 25 according to the invention. Coupling 25 shares many of the features of couplings 20 and 20′ as described herein but comprises three segments 28 attached to one another end to end to surround and define the central space 30 for receiving the pipe element. The third segment 28c comprises the same or substantially the same features as the first and second segments 28a, 28b. Although coupling 25 has three segments 28, a coupling having more than three segments is also practical. For example, the coupling may comprise four segments as disclosed herein attached to one another end to end to surround and define the central space 30.

FIG. 17 illustrates another example embodiment of a coupling 252 according to the disclosure. Coupling 252 shares many of the features of couplings 20 and 20′ as described above but substitutes a hinge 254 in place of corresponding lugs 40. An end of each segment 28a and 28b is connected via the hinge 254 joining the first and second segments 28a, 28b to one another. The hinge 254 defines a hinge axis 256 oriented transversely to the longitudinal axis 41 of the first fastener 44. The first and second segments 28a and 28b are pivotable about the hinge axis 256. Adjusting the fastener 44 pivots and thereby draws the first segment 28a and the second segment 28b toward one another. Optionally, the coupling 252 may include stop surfaces 42. Optionally, engagement between the stop surfaces 42 on the lugs 40 arrests rotation of the segments 28a, 28b relative to one another. In this example embodiment, hinge 254 comprises cantilevers 258, 260 engaging one another at a fulcrum 262. Cantilevers 258, 260 are joined by a ring 264, retained by projecting heads 266, 268 on each cantilever. Other forms of hinged joints, such as saddle and stirrup hinges, pinned hinges, cast hinges, and the like, are also contemplated.

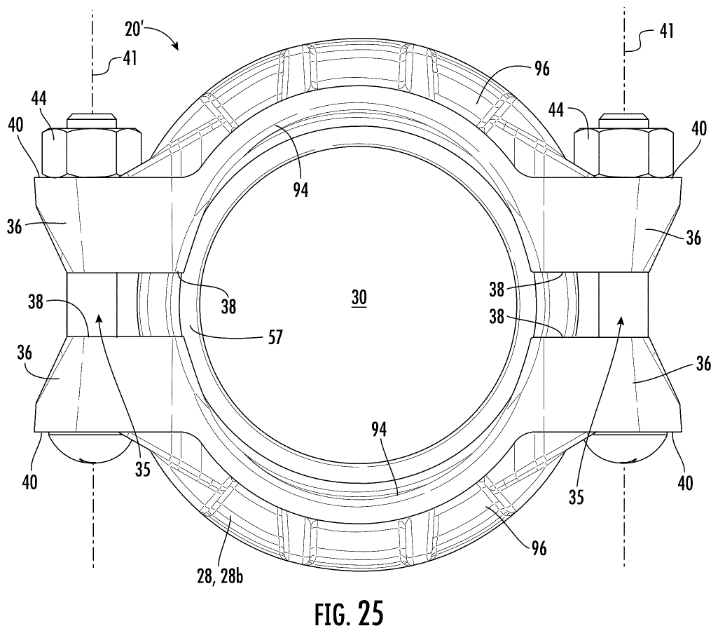

As shown in FIGS. 23 and 24, a transition coupling 420 is disclosed. Transition coupling 420 is configured to permit a pipe element 22 as disclosed herein to be joined to a traditional grooved pipe element 600 known in the art, such as those described in AWWA C-606 Standard for Grooved and Shouldered Joints as of the filing date. The pipe element 600 may be made of any conventional piping material, or other suitable materials, including malleable materials such as ferrous and nonferrous metals and polymers. Optionally, the pipe may be made of stainless steel. Optionally, the traditional grooved pipe element 600 is a ductile iron pipe. The transition coupling is therefore similar in many respects to coupling 20, and the description of transition coupling 420 will focus on certain features that are different from coupling 20. As shown in FIG. 25, similar to coupling 20, transition coupling 420 comprises segments 428, each having a first side 496 and an other side 498. First side 496 is configured to engage with a pipe element 22 using arcuate projections 494 as described above for coupling 20 and arcuate projection 94. However, other side 498 is intended to engage with a traditional grooved pipe element 600 having a sealing surface 604 and a traditional groove 602 with groove sides 603. The traditional groove 602 may be a groove that is not configured to wedge the arcuate projection of the coupling. Other side 498 has a lip 500 projecting radially inwardly for engaging with groove 602. Lip 500 has lip sides 502 and 504 facing one another on opposite sides of lip 500. However, unlike the engagement of arcuate projections 494 with groove 60 in pipe element 22, lip 500 is received within traditional groove 602 in a manner that provides for clearance between either or both of lip sides 502, 504 with groove sides 603 upon assembly of transition coupling 420. Segments 428 of transition coupling 400 capture a seal 457 therebetween within a channel 480. Seal 457 may be asymmetric about its center, having a protrusion 484 extending radially outwards from one side (as shown projecting from the side of the seal 457 adjacent segment first side 496), as well as a first leg 486 that is shaped and configured for engaging with the sealing surface 86 of pipe element 22 and a second leg 488 that is shaped and configured for engaging with the sealing surface 604 of traditional pipe element 600. Similarly, channel 480 may be asymmetric about its centerline, having a pocket 482 for receiving a protrusion 484 of the seal 457. The engagement of protrusion 484 with pocket 482 assists in ensuring that the seal is properly oriented when installed into transition coupling 420, in a manner that positions first leg 486 relative to the first side 496 for engagement with pipe element 22 and second leg 488 relative to the other side 498 for engagement with traditional pipe element 600.

Consistent with the above description, a method of assembling a combination of the pipe element 22 and the coupling 20, 20′ comprises inserting the pipe element 22 end first into the central space 30 of the coupling 20 in the preassembled state until at least one of the groove 60 and the bead 72 engages the arcuate projection. In some aspects, inserting the pipe element 22 comprises inserting the pipe element 22 until at least one of the second groove side surface 68 and the first bead side surface 74 engages the arcuate projection.

The method comprises adjusting the attachment members 36 to draw the plurality of segments 28 from an initial condition to a tightened condition, wherein the arcuate projection 94 wedges into the groove 60. Adjusting the attachment members 36 causes the first mating surface 100 to engage the first groove side surface 64 and the second mating surface 102 to engage the second groove side surface 68. Optionally, adjusting the attachment members 36 may cause the first groove side surface 64 and the second groove side surface 68 to flex away from each other. Adjusting the attachment members 36 causes the first groove side angle 88 to increase and the second groove side angle 90 to increase. Adjusting the attachment members 36 may cause the stop surfaces 42 on respective ends of the segments 28 to engage each other.

The coupling 20, 20′ may comprise a ring seal 57, and the ring seal 57 may not comprise a tongue or center leg. Although not necessary for the alignment of the respective groove and arcuate projection, the ring seal may comprise a tongue or center leg. A geometry of the arcuate projection 94 and the endform 80 of the pipe element 22 may facilitate alignment and mechanical engagement between the groove 60 and the arcuate projection 94 without requiring manual alignment of the arcuate projection 94 and the groove 60 or engagement by the pipe element 22 with a tongue or center leg of the ring seal (if present).

### Roller Sets

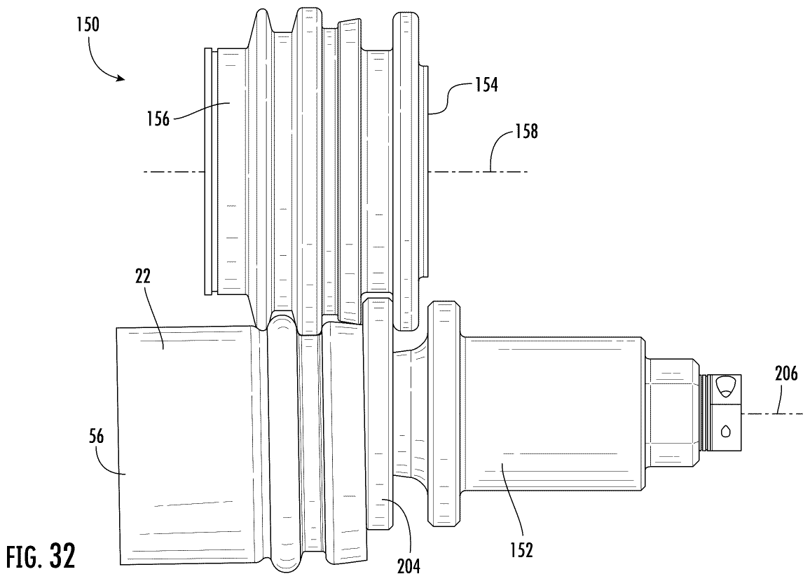

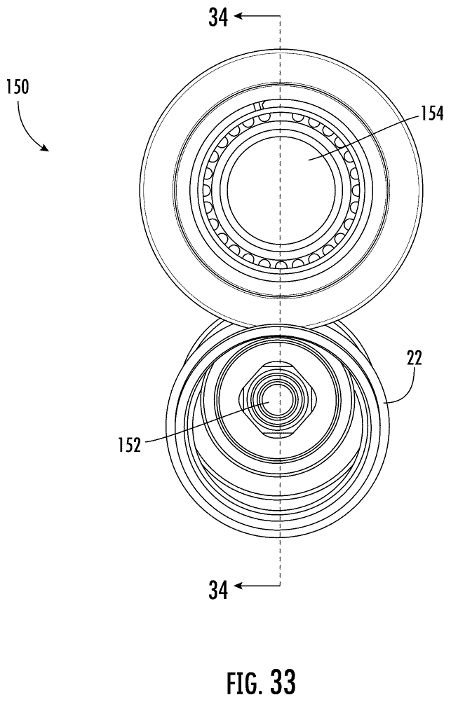

FIGS. 32-36 show an example roller set 150 according to the disclosure. Optionally, the roller set 150 may be used to form the pipe element 22 disclosed herein. The roller set 150 may be used to form the endform 80 of the pipe element. The roller set 150 comprises an outer roller 154 engageable with an outer surface of a pipe element. Optionally, the roller set 150 comprises an outer roller 154 engageable with the outer surface 56 of the pipe element 22. The outer roller 154 comprises an outer roller body 156 rotatable about an outer roller axis 158. The roller set 150 comprises an inner roller 152 engageable with an inner surface 151 of a pipe element. Optionally, the roller set 150 comprises an inner roller 152 engageable with the inner surface of the pipe element 22. The inner roller 152 comprises an inner roller body 204 rotatable about an inner roller axis 206. The inner roller 152 and the outer roller 154 are configured to align and cooperate to form the pipe element. Optionally, the inner roller 152 and the outer roller 154 are configured to align and cooperate to form the endform 80 of the pipe element 22. In an aligned configuration, the outer roller axis 158 and the inner roller axis 206 are parallel or substantially parallel (for example, within about 5° of parallel). As described below, the sidewall 50 of the pipe element 22 is compressed between the inner and outer rollers 152, 154 which cooperate to impart the described various shapes to the surfaces and sidewall of the pipe element 22.

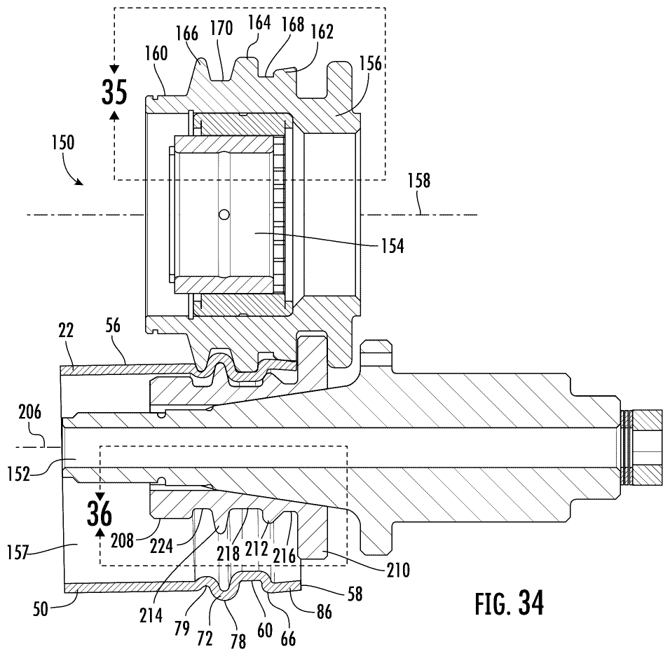

As shown in FIGS. 32 and 34, the example outer roller 154 comprises an outer roller body 156 rotatable about an outer roller axis 158 which may be a longitudinal axis. The outer roller body 156 has an outer surface 160 that comprises a plurality of raised features 162, 164, 166 that extend circumferentially around the outer roller body 156 and project radially away from the outer roller axis 158. A first raised feature 162, a second raised feature 164, and a third raised feature 166 are engageable with the pipe element 22, in this example the outer surface of the pipe element 22. The second raised feature 164 is positioned adjacent to the first raised feature 162 and between the first and third raised features 162, 166. As used herein to define the relationship between like features of the roller set, a first feature may be considered “adjacent” to a second like feature when such features are positioned sequentially along, or sequentially defined by, the outer surface of the roller body without any intervening like feature. For example, two raised features of the roller set can be considered “adjacent” to one another if no other raised feature is positioned in between such raised features, even if non-raised portions of the outer surface (e.g., cylindrical portions of the outer surface) are provided between the raised features.

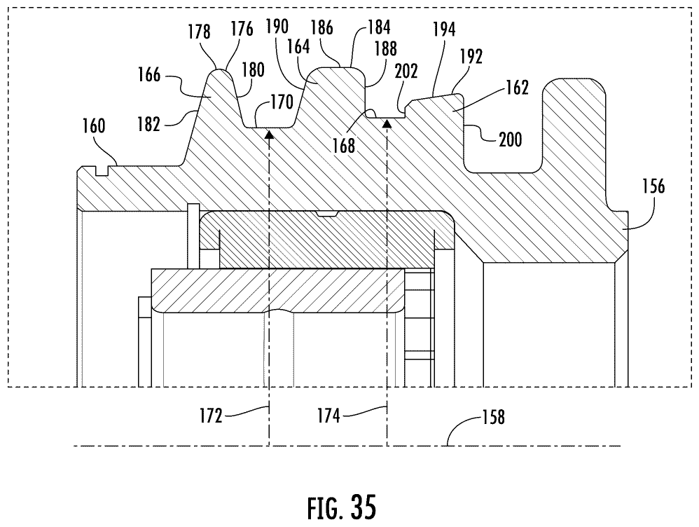

As shown in FIG. 35, the outer surface 160 of the outer roller body 156 comprises a first portion 168 positioned between the first raised feature 162 and the second raised feature 164, and a second portion 170 positioned between the second raised feature 164 and the third raised feature 166. The first portion 168 may be adjacent or contiguous with the first raised feature 162 and/or the second raised feature 164. The second portion 170 may be adjacent or contiguous with the second raised feature 164 and/or the third raised feature 166. The first portion 168 of the outer surface 160 of the outer roller body 156 may extend parallel or substantially parallel (for example within 5° of parallel) to the outer roller axis 158. A radius 172 of the outer surface 160 at the second portion 170 is less than a radius 174 of the outer surface 160 at the first portion 168 (as shown in FIG. 35).

The first raised feature 162 has a tip 192 comprising a frustoconical surface 194 extending lengthwise along the outer roller body 156 contiguous with a first side surface 200 and a second side surface 202. The first raised feature 162 may be located on the outer roller body 156 so that it can engage the outer surface of the pipe element 22 near its end 58. The frustoconical surface 194 has a smaller radius positioned proximal to the second raised feature 164 and a larger radius positioned distal to the second raised feature 164. The second side surface 202 of the first raised feature 162 is positioned between the first portion 168 of the outer surface 160 of the outer roller body and the first side surface 200 of the first raised feature 162. The first side surface 200 may extend perpendicularly or substantially perpendicularly (for example within 5° of perpendicular) to the first axis 158. The second side surface 202 may extend perpendicularly or substantially perpendicularly (for example within 5° of perpendicular) to the outer roller axis 158. The first raised feature 162 and its frustoconical surface 194 may be used to form a tapered end in the pipe element 22, for example frustoconical portion 86, and/or mitigate, control or prevent flaring of the end of the pipe element being rolled.

The second raised feature 164 may have a tip 184 comprising a flat surface 186 extending parallel or substantially parallel (for example within 5° of parallel) to the outer roller axis 158. The second raised feature 164 may be used to form the groove 60 in the pipe element and may be located on the outer roller body 156 so that it can engage the outer surface of the pipe element 22 where the groove should be formed. The flat surface 186 is contiguous with a first side surface 188 and a second side surface 190. The first side surface 188 of the second raised feature 164 is positioned between the first portion 168 of the outer surface 160 of the outer roller body 156 and the second side surface 190 of the second raised feature 164. The second side surface 190 of the second raised feature 164 may taper towards the first side surface 188 of the second raised feature 164 extending radially outwardly away from the outer roller axis 158. The first side surface 188 of the second raised feature 164 may extend perpendicularly or substantially perpendicularly (for example within 5° of perpendicular) to the outer roller axis 158. Alternatively, the first side surface 188 may taper towards the second side surface 190 extending radially outwardly away from the outer roller axis 158. The angular orientation of the first and second side surfaces 188, 190 of the second raised feature 164 may correspond to the desired angular orientation of the first and second groove side surfaces, respectively. The first portion 168 of the outer surface 160 is contiguous with the first side surface 188 of the second raised feature 164 and the second side surface 202 of the first raised feature 162.

The third raised feature 166 comprises a tip 176 having a curved surface 178 contiguous with a first side surface 180 and a second side surface 182. The third raised feature 166 may be used to form the second bead side surface 76 of the pipe element 22, and optionally, an indent 79 adjacent or contiguous with the second bead side surface 76. and may be located on the outer roller body 156 so that it can engage the outer surface of the pipe element 22 where the second bead side surface and/or indent should be formed. The first side surface 180 is positioned between the second portion 170 of the outer surface 160 and the second side surface 182 of the third raised feature 166. The first side surface 180 may taper towards the second side surface 182 extending radially outwardly away from the outer roller axis 158. The second side surface 182 may taper towards the first side surface 180 extending radially outwardly away from outer roller axis 158. The second portion 170 of the outer surface 160 may be contiguous with the second side surface 190 of the second raised feature 164 and the first side surface 180 of the third raised feature 166.

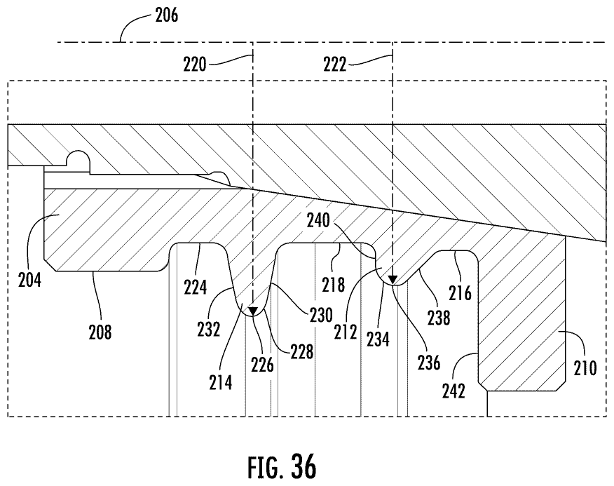

FIGS. 32, 34, and 36 show an example inner roller 152. The inner roller 152 comprises an inner roller body 204 rotatable about an inner roller axis 206, which may be a longitudinal axis. The inner roller body 204 has an outer surface 208 comprising a flange 210 extending circumferentially around the inner roller body 204 and projecting transversely to the inner roller axis 206. The outer surface 208 of the inner roller body 204 comprises a fourth raised feature 212 and a fifth raised feature 214 engageable with the pipe element 22 and extending circumferentially about the inner roller body 204. The fourth raised feature 212 and the fifth raised feature 214 project radially away from the inner roller axis 206. The fourth raised feature 212 is positioned between the flange 210 and the fifth raised feature 214. As shown in FIG. 36, the fifth raised feature 214 has a radius 220 as measured from the inner roller axis 206 greater than a radius 222 of the fourth raised feature 212.

The outer surface 208 of the inner roller body 204 comprises a third portion 216 positioned between the flange 210 and the fourth raised feature 212. The third portion 216 may be positioned adjacent or contiguous with the flange 210 and/or the fourth raised feature 212. The third portion 216 may extend parallel or substantially parallel (for example within 5° of parallel) to the inner roller axis 206. The outer surface 208 comprises a fourth portion 218 positioned between the fourth raised feature 212 and the fifth raised feature 214. The fourth portion 218 may be positioned adjacent or contiguous with the fourth raised feature 212 and/or the fifth raised feature 214. The fourth portion 218 extends parallel or substantially parallel (for example within 5° of parallel) to the inner roller axis 206. The outer surface 208 may comprise a fifth portion 224 positioned adjacent or contiguous with the fifth raised feature 214. The fifth portion 224 may extend parallel or substantially parallel (for example within 5° of parallel) to the inner roller axis 206.

The flange 210 comprises a flange side 242. The flange side 242 may be configured to engage the end 58 of the pipe element 22. The flange side 242 may extend perpendicularly or substantially perpendicularly (for example within 5° of perpendicular) to the inner roller axis 206. Alternatively, the flange side 242 may taper away from the third portion 216 extending radially outwardly from the inner roller axis 206.

The fourth raised feature 212 may have a tip 234 comprising a curved surface 236 contiguous with a first side surface 238 and a second side surface 240. The fourth raised feature 212 may be used to form the summit 66 in the pipe element 22 and may be located on the inner roller body 204 so that it can engage the inner surface 157 of the pipe element 22 where the summit should be formed. The first side surface 238 of the fourth raised feature 212 is positioned between the third portion 216 of the outer surface of the inner roller body and the second side surface 240 of the fourth raised feature 212. The second side surface 240 of the fourth raised feature 212 may extend perpendicularly or substantially perpendicularly (for example within 5° of perpendicular) to the inner roller axis 206. Optionally, the second side surface 240 may taper towards the first side surface 238 of the fourth raised feature 212 extending radially outwardly away from the inner roller axis 206. The first side surface 238 of the fourth raised feature 212 may taper towards the second side surface 240 of the fourth raised feature 212 extending radially outwardly away from the inner roller axis 206. The third portion 216 of the outer surface 208 may be contiguous with the first side surface 238 of the fourth raised feature 212 and the flange side 242 of the flange 210.

The fifth raised feature 214 may comprise a tip 226 having a curved surface 228 contiguous with a first side surface 230 and a second side surface 232. The fifth raised feature 214 may be used to form the summit 78 in the pipe element 22 and may be located on the inner roller body 204 so that it can engage the inner surface 157 of the pipe element 22 where the summit 78 should be formed. The first side surface 230 of the fifth raised feature 214 is positioned between the fourth portion 218 of the outer surface 208 of the inner roller body 204 and the second side surface 232 of the fifth raised feature 214. The first side surface 230 may taper towards the second side surface 232 extending radially outwardly away from the inner roller axis 206. The second side surface 232 may taper towards the first side surface 230 extending radially outwardly away from inner roller axis 206. The fourth portion 218 of the outer surface 208 may be contiguous with the first side surface 230 of the fifth raised feature 214 and the second side surface 240 of the fourth raised feature 212. The fifth portion 224 of the outer surface 208 may be contiguous with the second side surface 232 of the fifth raised feature 214.

The inner roller 152 and the outer roller 154 are configured to cooperate to form the region or endform 80 of the pipe element 22. When forming the endform 80, the outer roller axis 158 and the inner roller axis 206 may be parallel or substantially parallel (for example within 5° of parallel). When forming the pipe element 22:
the position of the first raised feature 162 of the outer roller body 156 may correspond to the position of the third portion 216 of the inner roller body 204;
the position of the first portion 168 of the outer roller body 156 may correspond to the position of the fourth raised feature 212 of the inner roller body 204;
the position of the second raised feature 164 of the outer roller body 156 may correspond to the position of the fourth portion 218 of the inner roller body 204;
the position of the second portion 170 of the outer roller body 156 may correspond to the position of the fifth raised feature 214 of the inner roller body 204; and
the position of the third raised feature 166 of the outer roller body 156 may correspond to the position of the fifth portion 224 of the inner roller body 204.

Cooperating features and portions may have corresponding axial positions to form the endform 80 of the pipe element 22. The cooperating features and portions may be positioned such that the axial centers of cooperating features and portions are offset along respective axes 158, 206 to prevent unwanted shearing of the pipe element 22. For example, in one optional configuration, the axial center of the second portion 168 and the axial center of the fourth raised feature 212 may be offset along respective axes 158, 206. The axial center of the second raised feature 164 and the fourth portion 218 may be offset along respective axes 158, 206. The axial center of the second portion 170 and the axial center of the fifth raised feature 214 may be axially aligned. The axial center of the third raised feature 166 and the axial center of the fifth portion 224 may be offset along the respective axes 158, 206.

As shown in FIG. 34, the first raised feature 162 of the outer roller body 156, the third portion 216 of the inner roller body 204, the first portion 168 of the outer roller body 156, the fourth raised feature 212 of the inner roller body 204, the second raised feature 164 of the outer roller body 156, and the fourth portion 218 of the inner roller body 204 may cooperate to form the endform 80 of the outer surface 56 of the pipe element 22 including the sealing surface 86.

The first portion 168 of the outer roller body 156, the fourth raised feature 212 of the inner roller body 204, the second raised feature 164 of the outer roller body 156, the fourth portion 218 of the inner roller body 204, the second portion 170 of the outer roller body 156, and the fifth raised feature 214 of the inner roller body 204 may cooperate to form the groove 60 of the pipe element 22.

The second raised feature 164 of the outer roller body 156, the fourth portion 218 of the inner roller body 204, the second portion 170 of the outer roller body 156, the fifth raised feature 214 of the inner roller body 204, the third raised feature 166 of the outer roller body 156, and the fifth portion 224 of the inner roller body 204 may cooperate to form the summit 78 of the pipe element 22.

The second portion 170 of the outer roller body 156, the fifth raised feature 214 of the inner roller body 204, the third raised feature 166 of the outer roller body 156, and the fifth portion 224 of the inner roller body 204 may cooperate for form the indent 79 and/or tubular portion 82 of the outer surface 56 of the pipe element 22.

Operation of an exemplary roller set 150 is illustrated in FIG. 32. In this example, the inner roller 152 is the driven roller (rotated, for example by an electric motor, not shown) and outer roller 154 is an idler. The outer roller 154 may be configured to move toward and away from the inner roller 152 (optionally via a yoke, not shown, movable by an actuator known in the industry, for example, a hydraulic actuator). With the outer roller 154 moved away from the inner roller 152, an inner surface of the pipe element 22 is positioned on the inner roller 152. Formation of the endform including the groove retains the pipe element 22 in engagement with the roller set 150 during roll forming by mechanical engagement. With the outer roller axis 158 of outer roller 154 and the inner roller axis 206 of inner roller 152 substantially parallel to one another, outer roller 154 is moved into contact with the outer surface of pipe element 22. Rotation is effected by driving the inner roller 152 about inner roller axis 206 in this example, which causes the pipe element 22 and outer roller 154 to rotate about axes 52 and 158 respectively. As the rollers and pipe element 22 rotate, the roller bodies deform the pipe element 22 according to the shapes defined by the outer surfaces 160, 208 of the roller bodies 156, 204 thereby roll forming the endform of the pipe element 22. After the pipe element 22 is formed, the outer roller 154 may be moved away from the inner roller 152 and the pipe element 22 may be disengaged from the inner roller 152.

Consistent with the above description, method for forming the endform 80 of the pipe element 22 using the roller set comprises positioning the inner surface 157 of the pipe element 22 on the inner roller 152 and into contact with the fifth raised feature 224. Positioning the inner surface of the pipe element 22 on the inner roller 220 comprises positioning the inner surface into contact with the fifth raised feature 214. The method comprises moving the second raised feature 164 of the outer roller 154 and the third raised feature 166 of the outer roller 154 into contact with the outer surface 56 of the pipe element 22. Moving the outer roller 154 into contact with the outer surface of the pipe element 22 comprises moving the second raised feature 164 and the third raised feature 166 into contact with the outer surface. The method may further comprise moving the first raised feature 162 of the outer roller 154 into contact with the outer surface of the pipe element 22. The method comprises rotating the inner roller 152, thereby rotating the pipe element 22 and the outer roller 154. The method comprises forcing the inner roller 152 and the outer roller 154 toward one another to deform the pipe element 22 to form the endform 80. The method may further comprise contacting the flange 210 of the inner roller 152 with the end 58 of the pipe element 22.

The inner roller 152 is a driven roller and the outer roller 154 is an idler. The outer roller 154 is configured to move toward and away from the inner roller 152. Formation of the endform 80 retains the pipe element 22 in engagement with the roller set during roll forming by mechanical engagement. After the pipe element 22 is formed, the outer roller 154 is moved away from the inner roller 152 and the pipe element 22 is disengaged from the inner roller 152.

### Conclusion

It is expected that the pipe elements, couplings, and rollers described herein will address one or more of the challenges associated with obtaining rigid pipe connections and/or with aligning couplings and pipe elements by providing one or more of the following features:
(1) The engagement between the bead and the arcuate projection during insertion will allow couplings and pipe elements to be properly aligned without using ring seals with tongues or center legs and without necessitating manual alignment;
(2) The engagement between the bead and the arcuate projection during insertion will reduce the risk of misassembly;
(3) Removing the need for ring seals with center legs and tongues will allow for thinner and/or lighter couplings; The wedging engagement between the arcuate projection and the corresponding groove provides more consistent forceful contact between the mating surfaces of the arcuate projection and the side surfaces of the groove. This more consistent engagement may reduce or eliminate the play between the coupling key and the groove that can reduce rigidity in conventional grooved coupling joints.;
(4) Because the wedging action does not rely primarily on clamping the groove floor, the disclosed pipe elements and couplings may provide improved rigidity even for thin wall pipe applications where pipe stiffness is reduced; and/or
(3) The combination of the groove 60 and bead 72 in the endform may increase the stiffness and rigidity of the pipe element in the region of the endform. The geometry of the groove 60 and bead 72 may act similarly to corrugations, providing increased resistance to deformation and bending forces. In some aspects, the increased stiffness provided by the groove 60 and bead 72 may allow the use of thinner wall pipe while maintaining sufficient structural integrity at the joint.

All of the embodiments of the claimed disclosure described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.
Aspect 1: A pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface of said sidewall, said groove extending circumferentially around said bore, said groove comprising:
a first groove side surface terminating at a first end,
a second groove side surface facing said first groove side surface and in spaced apart relation from said first groove side surface along said longitudinal axis, wherein said first groove side surface is positioned between said end of said pipe element and said second groove side surface, and
a floor surface contiguous with (connected, either directly or through a transition region, to) said first groove side surface and said second groove side surface,
wherein said groove is configured to receive an arcuate projection of a coupling; and
a bead defined by said outer surface, said bead extending circumferentially around said bore, wherein said groove is positioned between said end of said pipe element and said bead, said bead comprising:
a first bead side surface, and
a first summit, wherein said first bead side surface is positioned between said groove and said first summit.
Aspect 2: The pipe element according to aspect 1, wherein said first groove side surface is oriented at a first groove side angle relative to said floor surface and said second groove side surface is oriented at a second groove side angle relative to said floor surface.
Aspect 3: The pipe element according to aspect 2, wherein said second groove side angle is greater than said first groove side angle.
Aspect 4: The pipe element according to any one of aspects 2 or 3, wherein said first groove side angle is a first obtuse angle.
Aspect 5: The pipe element according to any one of aspects 2 to 4, wherein said second groove side angle is a second obtuse angle.
Aspect 6: The pipe element according to any one of aspects 2 to 5, wherein said first groove side angle and said second groove side angle are each from about 90° to about 120°.
Aspect 7: The pipe element according to any one of aspects 1 to 6, wherein said floor surface is oriented parallel or substantially parallel to said longitudinal axis.
Aspect 8: The pipe element according to any one of aspects 1 to 7, wherein a radius of said floor surface measured from said longitudinal axis is less than any other radius of said outer surface of said endform measured from said longitudinal axis.
Aspect 9: The pipe element according to any one of aspects 1 to 8, wherein a radius of said floor surface measured from said longitudinal axis is less than a minimum radius of said tubular portion measured from said longitudinal axis.
Aspect 10: The pipe element according to any one of aspects 1 to 9, wherein a radius of said first summit measured from said longitudinal axis is greater than any other radius of said outer surface of said endform measured from said longitudinal axis.
Aspect 11: The pipe element according to any one of aspects 1 to 10, wherein a radius of said first summit measured from said longitudinal axis is greater than a maximum radius of said tubular portion measured from said longitudinal axis.
Aspect 12: The pipe element according to any one of aspects 1 to 11, wherein a radius of said first summit measured from said longitudinal axis is a maximum radius of said outer surface of a portion of said sidewall extending from said end of said pipe element to said first summit measured from said longitudinal axis.
Aspect 13: The pipe element according to any one of aspects 1 to 12, wherein said first bead side surface is contiguous with (connected, either directly or through a transition region, to) said second groove side surface.
Aspect 14: The pipe element according to any one of aspects 2 to 13, wherein said second groove side surface and said first bead side surface are oriented at the same or substantially the same angle relative to said floor surface.
Aspect 15: The pipe element according to any one of aspects 1 to 14, wherein said groove is configured to flex open to receive said arcuate projection of said coupling, wherein said bead is configured to flex closed as said groove flexes open.
Aspect 16: The pipe element according to any one of aspects 1 to 15, wherein said bead has a geometry that causes said bead to act like a spring such that a base end of said first bead side surface is biased towards said end of said pipe element along said longitudinal axis.
Aspect 17: The pipe element according to any one of aspects 1 to 16, wherein said bead further comprises a second bead side surface extending from said first summit, wherein said first summit is positioned between said first bead side surface and said second bead side surface.
Aspect 18: The pipe element according to aspect 17, wherein said second bead side surface has a larger radius measured from said longitudinal axis at a point closer to said first summit than at a point farther from said first summit.
Aspect 19: The pipe element according to any one of aspects 17 or 18, wherein said tubular portion is adjacent or contiguous with (connected, either directly or through a transition region, to) said second bead side surface.
Aspect 20: The pipe element according to any one of aspects 17 to 19, wherein said endform further comprises an indent adjacent or contiguous with said second bead side surface.
Aspect 21: The pipe element according to aspect 20, wherein said indent is positioned between said second bead side surface and said tubular portion.
Aspect 22: The pipe element according to any one of aspects 20 or 21, wherein said indent comprises indicia identifying a model number or source of said pipe element.
Aspect 23: The pipe element according to any one of aspects 1 to 22, wherein said first bead side surface extends from said second groove side surface to said first summit.
Aspect 24: The pipe element according to any one of aspects 1 to 23, wherein said first bead side surface comprises a base end that is closer to said floor surface of said groove than to said first summit.
Aspect 25: The pipe element according to any one of aspects 1 to 24, wherein said first end of said first groove side surface is a second summit, wherein a radius of said first summit measured from said longitudinal axis is greater than a radius of said second summit measured from said longitudinal axis.
Aspect 26: The pipe element according to any one of aspects 1 to 25, wherein said endform further comprises a sealing surface positioned between said first groove side surface and said end of said pipe element.
Aspect 27: The pipe element according to aspect 26, wherein said sealing surface extends from said first groove side surface to said end of said pipe element.
Aspect 28: The pipe element according to any one of aspects 26 or 27, wherein said sealing surface is frustoconical.
Aspect 29: The pipe element according to aspect 28, wherein a radius of said sealing surface measured from said longitudinal axis at a first point is less than a radius of said sealing surface measured from said longitudinal axis at a second point, wherein said first point is closer to said end of said pipe element than said second point to said end of said pipe element.
Aspect 30: The pipe element according to aspect 28, wherein a radius of said sealing surface measured from said longitudinal axis at a first point is larger than a radius of said sealing surface measured from said longitudinal axis at a second point, wherein said first point is closer to said end of said pipe element than said second point to said end of said pipe element.
Aspect 31: The pipe element according to any one of aspects 26 to 30, wherein said sealing surface is cylindrical or substantially cylindrical.
Aspect 32: The pipe element according to aspect 25, wherein said endform further comprises a sealing surface positioned between said second summit and said end of said pipe element.
Aspect 33: The pipe element according to aspect 32, wherein said sealing surface extends from said second summit to said end of said pipe element.
Aspect 34: The pipe element according to any one of aspects 32 or 33, wherein said sealing surface is frustoconical such that said sealing surface has a smaller radius measured from said longitudinal axis at a point closer to said end of said pipe element than at a point further from said end of said pipe element.
Aspect 35: The pipe element according to any one of aspects 1 to 34, wherein said pipe element is a thin wall pipe.
Aspect 36: The pipe element according to any one of aspects 1 to 35, wherein said pipe element is a stainless steel pipe.
Aspect 37: The pipe element according to any one of aspects 2 to 36, wherein said groove is configured such that:
prior to receiving said arcuate projection, said groove is in an initial condition, wherein in said initial condition, said first groove side angle is a first angle and said second groove side angle is a second angle;
after receiving said arcuate projection, said groove is in a tightened condition, wherein in said tightened condition, said first groove side angle is a third angle and said second groove side angle is a fourth angle; and
said third angle is greater than said first angle and said fourth angle is greater than said second angle.
Aspect 38: The pipe element according to aspect 37, wherein said bead has a bead base width extending parallel or substantially parallel to said longitudinal axis, and wherein:
in said initial condition, said bead base width is a first width;
in said tightened condition, said bead base width is a second width; and
said second width is less than said first width.
Aspect 39: The pipe element according to any one of aspects 1 to 38, wherein said radius of said floor surface of said groove measured from said longitudinal axis is less than any other radius of said outer surface of said endform measured from said longitudinal axis.
Aspect 40: The pipe element according to any one of aspects 1 to 39, wherein said radius of said floor surface of said groove measured from said longitudinal axis is less than a minimum radius of said outer surface of said tubular portion measured from said longitudinal axis.
Aspect 41: In combination, a pipe element and a coupling, said pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface of said sidewall, said groove extending circumferentially around said bore, said groove comprising:
a first groove side surface,
a second groove side surface facing said first groove side surface and in spaced apart relation from said first groove side surface along said longitudinal axis, wherein said first groove side surface is positioned between said end of said pipe element and said second groove side surface, and
a floor surface contiguous with (connected, either directly or through a transition region, to) said first groove side surface and said second groove side surface; and
a bead defined by said outer surface, said bead extending circumferentially around said bore, said bead comprising:
a first bead side surface contiguous with (connected, either directly or through a transition region, to) said second groove side surface, and
a first summit having a radius measured from said longitudinal axis, wherein said first bead side surface is positioned between said first summit and said second groove side surface;
said coupling comprising:
a plurality of segments attached to one another end to end surrounding said end of said pipe element, wherein the attached plurality of segments form a loop around a central space;
attachment members positioned at each end of said segments for attaching said segments to one another; and
an arcuate projection positioned on a side of each of said segments and configured to engage with said groove, said arcuate projection projecting radially inwardly from said side, said arcuate projection comprising:
a first mating surface configured to engage said first groove side surface,
a second mating surface facing away from said first mating surface and configured to engage said second groove side surface, and
a third mating surface contiguous with (connected, either directly or through a transition region, to) said first mating surface and said second mating surface and facing said central space, said third mating surface positioned between said first mating surface and said second mating surface,
wherein, when received by said groove, said arcuate projection is configured to wedge into said groove.
Aspect 42: The combination according to aspect 41, wherein said first groove side surface is oriented at a first groove side angle relative to said floor surface and said second groove side surface is oriented at a second groove side angle relative to said floor surface.
Aspect 43: The combination according to aspect 42, wherein said second groove side angle is greater than said first groove side angle.
Aspect 44: The combination according to any one of aspects 42 or 43, wherein said first groove side angle is an obtuse angle and said second groove side angle is an obtuse angle.
Aspect 45: The combination according to any one of aspects 41 to 44, wherein said floor surface has a width extending parallel or substantially parallel to said longitudinal axis, wherein said third mating surface has a width extending perpendicularly or substantially perpendicularly to the length of said arcuate projection, wherein said width of said third mating surface is greater than said width of said floor surface of said groove.
Aspect 46: The combination according to any one of aspects 41 to 45, wherein said third mating surface has a width extending perpendicularly or substantially perpendicularly to the length of said arcuate projection, wherein said first mating surface tapers towards said second mating surface and said second mating surface tapers towards said first mating surface such that a base of said arcuate projection is wider than said width of said third mating surface.
Aspect 47: The combination according to any one of aspects 41 to 46, wherein said plurality of segments are configured to be drawn towards one another from an initial condition to a tightened condition.
Aspect 48: The combination according to aspect 47, wherein in said initial condition, said third mating surface is spaced from said floor surface of said groove by a first distance, and in said tightened condition, said third mating surface engages said floor surface of said groove or said third mating surface is spaced from said floor surface of said groove by a second distance, wherein said second distance is less than said first distance.
Aspect 49: The combination according to any one of aspects 47 or 48, wherein said first mating surface and said second mating surface engage said first groove side surface and said second groove side surface, respectively, before said segments reach said tightened condition.
Aspect 50: The combination according to any one of aspects 47 to 49, wherein as said segments are drawn towards each other to said tightened condition, said arcuate projection wedges into said groove.
Aspect 51: The combination according to any one of aspects 42 to 50, wherein said plurality of segments are configured to be drawn towards one another from an initial condition to a tightened condition, and wherein:
in said initial condition, said first groove side angle is a first angle and said second groove side angle is a second angle;
in said tightened condition, said first groove side angle is a third angle and said second groove side angle is a fourth angle; and
said third angle is greater than said first angle and said fourth angle is greater than said second angle.
Aspect 52: The combination according to aspect 51, wherein as said arcuate projection wedges into said groove, said bead flexes closed by said first bead side surface being pushed towards a second bead side surface of said bead along said longitudinal axis.
Aspect 53: The combination according to aspect 52, wherein:
said bead has a bead base width extending parallel or substantially parallel to said longitudinal axis;
in said initial condition, said bead base width is a first width;
in said tightened condition, said bead base width is a second width; and
said second width is less than said first width.
Aspect 54: The combination according to any one of aspects 41 to 53, wherein said bead has a geometry that causes said bead to act like a spring such that a base end of said first bead side surface is biased towards said end of said pipe element along said longitudinal axis thereby facilitating wedging of said arcuate projection.
Aspect 55: The combination according to any one of aspects 41 to 54, wherein said plurality of segments are attached to one another end to end in a preassembled state, wherein in said preassembled state, said plurality of segments are supported in spaced relation while attached to one another to allow insertion of said pipe element into said central space.
Aspect 56: The combination according to aspect 55, wherein said radius of said first summit measured from said longitudinal axis is greater than a distance measured from said longitudinal axis to said third mating surface of said arcuate projection when said coupling is in said preassembled state such that said arcuate projection engages at least one of said second groove side surface and said first bead side surface and said pipe element is prevented from moving further into said central space.
Aspect 57: The combination according to aspect 56, wherein said coupling comprises a ring seal configured to support said plurality of segments in said preassembled state.
Aspect 58: The combination according to any one of aspects 41 to 57, wherein said plurality of segments comprises a first segment and a second segment, wherein said first segment and said second segment are attached to one another at one end by a hinge and at an opposite end by an adjustable fastener.
Aspect 59: The combination according to any one of aspects 41 to 58, wherein said plurality of segments comprises more than two segments attached to one another end to end to form said loop around said central space.
Aspect 60: The combination according to any one of aspects 41 to 59, wherein said plurality of segments comprises a first segment and a second segment, wherein said first segment and said second segment are attached to one another at both ends by adjustable fasteners.
Aspect 61: The combination according to any one of aspects 41 to 60, wherein each of said segments comprises lugs projecting from opposite ends of each segment, each lug comprising a stop surface, wherein in a tightened condition, said stop surfaces on respective ends of said segments engage each other.
Aspect 62: The combination according to any one of aspects 41 to 61, wherein said coupling comprises a ring seal configured to be captured and compressed between said segments and said pipe element when said attachment members are tightened.
Aspect 63: The combination according to aspect 62, wherein said ring seal does not comprise a tongue or center leg.
Aspect 64: The combination according to any one of aspects 41 to 63, wherein said plurality of segments are configured to be drawn towards one another to a tightened condition.
Aspect 65: The combination according to aspect 64, wherein in said tightened condition, said first mating surface engages said first groove side surface.
Aspect 66: The combination according to any one of aspects 64 or 65, wherein in said tightened condition, said second mating surface engages said second groove side surface.
Aspect 67: The combination according to any one of aspects 64 to 66, wherein in said tightened condition, said third mating surface engages said floor surface.
Aspect 68: The combination according to any one of aspects 41 to 67, wherein said first mating surface tapers towards said second mating surface and said second mating surface tapers towards said first mating surface such that a base of said arcuate projection is wider than a width of said third mating surface.
Aspect 69: The combination according to any one of aspects 41 to 68, wherein said pipe element is a thin wall pipe.
Aspect 70: The combination according to any one of aspects 41 to 69, wherein said pipe element is a stainless steel pipe.
Aspect 71: The combination according to any one of aspects 41 to 70, wherein said wedging action of said arcuate projection and said groove around the circumference of said pipe element promotes a more rigid joint.
Aspect 72: A method of assembling a combination of a pipe element and a coupling, said pipe element having a sidewall surrounding a longitudinal axis and defining a bore, said longitudinal axis being a central axis of said pipe element, said sidewall having an outer surface comprising an endform, said endform comprising a groove defined by said outer surface, said groove extending circumferentially around said bore, said endform further comprising a bead defined by said outer surface, wherein said groove is positioned between an end of said pipe element and said bead; said coupling comprising a plurality of segments attached to one another end to end forming a loop around a central space, attachment members for attaching said segments to one another, and an arcuate projection positioned on a side of each of said segments; said method comprising:
inserting said pipe element end first into said central space of said coupling in a preassembled state until at least one of said groove and said bead engages said arcuate projection, wherein, in said preassembled state, said segments are attached to one another end to end; and
adjusting said attachment members to draw said plurality of segments from an initial condition to a tightened condition, wherein in said tightened condition, said arcuate projection wedges into said groove.
Aspect 73: The method according to aspect 72, wherein said groove comprises, a first groove side surface, a second groove side surface facing said first groove side surface and in spaced apart relation from said first groove side surface along said longitudinal axis, and a floor surface contiguous with (connected, either directly or through a transition region, to) said first groove side surface and said second groove side surface.
Aspect 74: The method according to aspect 73, wherein said arcuate projection comprises a first mating surface, a second mating surface, and a third mating surface contiguous with (connected, either directly or through a transition region, to) said first mating surface and said second mating surface.
Aspect 75: The method according to aspect 74, wherein adjusting said attachment members causes said first mating surface to engage said first groove side surface and said second mating surface to engage said second groove side surface.
Aspect 76: The method according to any one of aspects 73 to 75, wherein adjusting said attachment members causes said arcuate projection to cause said first groove side surface and said second groove side surface to flex away from each other.
Aspect 77: The method according to any one of aspects 73 to 76, wherein said first groove side surface is oriented at a first groove side angle relative to said floor surface and said second groove side surface is oriented at a second groove side angle relative to said floor surface.
Aspect 78: The method according to aspect 77, wherein adjusting said attachment members causes said first groove side angle to increase and said second groove side angle to increase.
Aspect 79: The method according to any one of aspects 77 or 78, wherein said first groove side angle is an obtuse angle and said second groove side angle is an obtuse angle.
Aspect 80: The method according to any one of aspects 77 to 79, wherein said second groove side angle is greater than said first groove side angle.
Aspect 81: The method according to any one of aspects 74 to 80, wherein in said initial condition, said third mating surface is spaced from said floor surface by a first distance, and in said tightened condition, said third mating surface is spaced from said floor surface by a second distance less than said first distance or said third mating surface engages said floor surface.
Aspect 82: The method according to any one of aspects 74 to 81, wherein said floor surface has a width extending parallel or substantially parallel to said longitudinal axis, and wherein said third mating surface has a width extending perpendicularly or substantially perpendicularly to a length of said arcuate projection, wherein said width of said third mating surface is greater than said width of said floor surface.
Aspect 83: The method according to any one of aspects 73 to 82, further comprising, prior to adjusting said attachment members, inserting said pipe element end first into said central space of said coupling in said preassembled state until said second groove side surface engages said arcuate projection.
Aspect 84: The method according to any one of aspects 73 to 83, wherein said arcuate projection slides along said second groove side surface as said attachment members are adjusted to align said arcuate projection and said groove.
Aspect 85: The method according to any one of aspects 72 to 84, wherein said plurality of segments comprise lugs having stop surfaces, and wherein adjusting said attachment members causes said stop surfaces on respective ends of said segments to engage each other.
Aspect 86: The method according to any one of aspects 72 to 85, wherein said pipe element is a thin wall pipe.
Aspect 87: The method according to any one of aspects 72 to 86, wherein said pipe element is a stainless steel pipe.
Aspect 88: The method according to any one of aspects 72 to 87, wherein adjusting said attachment members causes said bead to flex closed.
Aspect 89: The method according to aspect 88, wherein said bead comprises a first bead side surface, and wherein adjusting said attachment members causes said first bead side surface to move away from said end of said pipe element.
Aspect 90: The method according to any one of aspects 88 or 89, wherein: said bead has a bead base width extending parallel or substantially parallel to said longitudinal axis;
in said initial condition, said bead base width is a first width;
in said tightened condition, said bead base width is a second width; and
said second width is less than said first width.
Aspect 91: The method according to any one of aspects 72 to 90, wherein said bead acts like a spring to facilitate wedging of said arcuate projection.
Aspect 92: The method according to any one of aspects 72 to 91, wherein said bead comprises a first summit having a radius measured from said longitudinal axis, and wherein said radius of said first summit is greater than a distance measured from said longitudinal axis to said arcuate projection when said coupling is in said preassembled state such that said pipe element is prevented from moving further into said central space upon said engagement of at least one of said groove and said bead with said arcuate projection.
Aspect 93: The method according to any one of aspects 72 to 92, wherein said arcuate projection slides along at least one of said groove and said bead as said attachment members are adjusted to align said arcuate projection and said groove.
Aspect 94: The method according to any one of aspects 72 to 93, wherein said coupling comprises a ring seal, and wherein said ring seal does not comprise a tongue or center leg.
Aspect 95: The method according to any one of aspects 72 to 94, wherein a geometry of said arcuate projection and said endform of said pipe element facilitates alignment and mechanical engagement between said groove and said arcuate projection without requiring manual alignment of said arcuate projection and said groove.
Aspect 96: The method according to any one of aspects 72 to 95, wherein said wedging of said arcuate projection into said groove around the circumference of said pipe element promotes a more rigid joint.
Aspect 97: The method according to any one of aspects 72 to 96, wherein said endform deforms in response to said wedging.
Aspect 98: The method according to aspect 97, wherein said pipe element is made of a malleable material.
Aspect 99: The method according to any one of aspects 72 to 98, wherein said plurality of segments comprises a first segment and a second segment, wherein said first segment and said second segment are attached to one another at one end by a hinge and at an opposite end by an adjustable fastener.
Aspect 100: The method according to any one of aspects 72 to 99, wherein said plurality of segments comprises more than two segments attached to one another end to end to form said loop around said central space.
Aspect 101: The method according to any one of aspects 72 to 100, wherein said plurality of segments comprises a first segment and a second segment, wherein said first segment and said second segment are attached to one another at both ends by adjustable fasteners.
Aspect 102: The method according to any one of aspects 72 to 101, wherein said coupling comprises a ring seal configured to be captured and compressed between said segments and said pipe element when said attachment members are adjusted.
Aspect 103: The method according to aspect 102, wherein said ring seal supports said plurality of segments in said preassembled state.
Aspect 104: The method according to any one of aspects 72 to 103, wherein said endform comprises a sealing surface positioned between said groove and said end of said pipe element.
Aspect 105: The method according to aspect 104, wherein said coupling comprises a ring seal having a pipe side leg, and wherein adjusting said attachment members compresses said ring seal such that said pipe side leg engages said sealing surface.
Aspect 106: The method according to any one of aspects 104 or 105, wherein said sealing surface is frustoconical.
Aspect 107: The method according to any one of aspects 104 to 106, wherein said sealing surface is cylindrical or substantially cylindrical.
Aspect 108: A roller set comprising:
an outer roller engageable with an outer surface of a pipe element, said outer roller comprising an outer roller body rotatable about an outer roller axis, said outer roller body having an outer surface comprising:
a first raised feature engageable with said pipe element and extending circumferentially about said outer roller body and projecting radially away from said outer roller axis,
a second raised feature engageable with said pipe element and extending circumferentially about said outer roller body and projecting radially away from said outer roller axis,
a third raised feature engageable with said pipe element and extending circumferentially about said outer roller body and projecting radially away from said outer roller axis, said second raised feature being positioned between said first and third raised features,
a first portion positioned between said first raised feature and said second raised feature of said outer roller body, and
a second portion positioned between said second raised feature and said third raised feature of said outer roller body,
wherein a radius of said outer surface at said second portion of said outer roller body is less than a radius of said outer surface at said first portion of said outer roller body; and
an inner roller engageable with an inner surface of said pipe element, said inner roller comprising an inner roller body rotatable about an inner roller axis, said inner roller body having an outer surface comprising:
a flange extending circumferentially around said inner roller body and projecting transversely to said inner roller axis,
a fourth raised feature engageable with said pipe element and extending circumferentially about said inner roller body and projecting radially away from said inner roller axis,
a fifth raised feature engageable with said pipe element and extending circumferentially about said inner roller body and projecting radially away from said inner roller axis, wherein said fourth raised feature is positioned between said flange and said fifth raised feature,
a third portion positioned between said flange and said fourth raised feature, and
a fourth portion positioned between said fourth raised feature and said fifth raised feature,
wherein said fifth raised feature has a radius greater than a radius of said fourth raised feature.
Aspect 109: The roller set according to aspect 108, wherein said inner roller and said outer roller are configured to align and cooperate to form an endform of said pipe element, wherein in an aligned configuration, said outer roller axis and said inner roller axis are parallel or substantially parallel.
Aspect 110: The roller set according to aspect 109, wherein, in said aligned configuration, said first raised feature of said outer roller body cooperates with said third portion of said inner roller body.
Aspect 111: The roller set according to any one of aspects 109 or 110, wherein, in said aligned configuration, said first portion of said outer roller body cooperates with said fourth raised feature of said inner roller body.
Aspect 112: The roller set according to any one of aspects 109 to 111, wherein, in said aligned configuration, said second raised feature of said outer roller body cooperates with said fourth portion of said inner roller body.
Aspect 113: The roller set according to any one of aspects 109 to 112, wherein, in said aligned configuration, said second portion of said outer roller body cooperates with said fifth raised feature of said inner roller body.
Aspect 114: The roller set according to any one of aspects 109 to 113, wherein, in said aligned configuration, said third raised feature of said outer roller body cooperates with a fifth portion of said inner roller body, said fifth portion positioned adjacent or contiguous with said fifth raised feature.
Aspect 115: The roller set according to any one of aspects 108 to 114, wherein said third raised feature comprises a tip having a curved surface.
Aspect 116: The roller set according to aspect 115, wherein said third raised feature comprises a first side surface and a second side surface, said first side surface positioned between said second portion of said outer surface of said outer roller body and said second side surface, wherein said curved surface is contiguous with (connected, either directly or through a transition region, to) said first side surface and said second side surface.
Aspect 117: The roller set according to aspect 116, wherein said first side surface tapers towards said second side surface extending radially outwardly away from said outer roller axis.
Aspect 118: The roller set according to any one of aspects 116 or 117, wherein said second side surface tapers towards said first side surface extending radially outwardly away from said outer roller axis.
Aspect 119: The roller set according to any one of aspects 108 to 118, wherein said second raised feature has a tip comprising a flat surface extending parallel or substantially parallel to said outer roller axis.
Aspect 120: The roller set according to aspect 119, wherein said second raised feature comprises a first side surface and a second side surface, said first side surface positioned between said first portion and said second side surface, wherein said flat surface is contiguous with (connected, either directly or through a transition region, to) said first side surface and said second side surface.
Aspect 121: The roller set according to aspect 120, wherein said second side surface tapers towards said first side surface extending radially outwardly away from said outer roller axis.
Aspect 122: The roller set according to any one of aspects 120 or 121, wherein said first side surface extends perpendicularly or substantially perpendicularly to said outer roller axis.
Aspect 123: The roller set according to any one of aspects 120 to 122, wherein said first side surface tapers towards said second side surface extending radially outwardly away from said outer roller axis.
Aspect 124: The roller set according to any one of aspects 108 to 123, wherein said first raised feature has a tip comprising a frustoconical surface extending lengthwise along said outer roller body, said frustoconical surface having a smaller radius positioned proximal to said second raised feature and a larger radius positioned distal to said second raised feature.
Aspect 125: The roller set according to aspect 124, wherein said second raised feature comprises a first side surface and a second side surface, wherein said second side surface is positioned between said first portion of said outer surface and said first side surface, and wherein said frustoconical surface is contiguous with (connected, either directly or through a transition region, to) said first side surface and said second side surface.
Aspect 126: The roller set according to aspect 125, wherein said first side surface extends perpendicularly or substantially perpendicularly to said outer roller axis.
Aspect 127: The roller set according to any one of aspects 125 or 126, wherein said second side surface extends perpendicularly or substantially perpendicularly to said outer roller axis.
Aspect 128: The roller set according to any one of aspects 116 to 127, wherein said second portion of said outer surface is contiguous with (connected, either directly or through a transition region, to) said second side surface of said second raised feature and said first side surface of said third raised feature.
Aspect 129: The roller set according to any one of aspects 125 to 128, wherein said first portion of said outer surface is contiguous with (connected, either directly or through a transition region, to) said first side surface of said second raised feature and said second side surface of said first raised feature.
Aspect 130: The roller set according to any one of aspects 108 to 129, wherein said first portion extends parallel or substantially parallel to said outer roller axis.
Aspect 131: The roller set according to any one of aspects 108 to 130, wherein said second portion extends parallel or substantially parallel to said outer roller axis.
Aspect 132: The roller set according to any one of aspects 108 to 131, wherein said second raised feature is configured to form a groove in said pipe element.
Aspect 133: The roller set according to any one of aspects 108 to 132, wherein said first raised feature is configured to form a sealing surface in said pipe element.
Aspect 134: The roller set according to any one of aspects 108 to 133, wherein said third raised feature is configured to form a second bead side surface in said pipe element.
Aspect 135: The roller set according to any one of aspects 108 to 134, wherein said fifth raised feature comprises a tip having a curved surface.
Aspect 136: The roller set according to aspect 135, wherein said fifth raised feature comprises a first side surface and a second side surface, said first side surface positioned between said fourth portion of said outer surface of said inner roller body and said second side surface, wherein said curved surface is contiguous with (connected, either directly or through a transition region, to) said first side surface and said second side surface.
Aspect 137: The roller set according to aspect 136, wherein said first side surface tapers towards said second side surface extending radially outwardly away from said inner roller axis.
Aspect 138: The roller set according to any one of aspects 136 or 137, wherein said second side surface tapers towards said first side surface extending radially outwardly away from said inner roller axis.
Aspect 139: The roller set according to any one of aspects 108 to 138, wherein said fourth raised feature has a tip comprising a curved surface.
Aspect 140: The roller set according to aspect 139, wherein said fourth raised feature comprises a first side surface and a second side surface, said first side surface positioned between said third portion and said second side surface, wherein said curved surface is contiguous with (connected, either directly or through a transition region, to) said first side surface and said second side surface.
Aspect 141: The roller set according to aspect 140, wherein said second side surface extends perpendicularly or substantially perpendicularly to said inner roller axis.
Aspect 142: The roller set according to any one of aspects 140 or 141, wherein said first side surface tapers towards said second side surface extending radially outwardly away from said inner roller axis.
Aspect 143: The roller set according to any one of aspects 108 to 142, wherein said flange comprises a flange side.
Aspect 144: The roller set according to aspect 143, wherein said flange side extends perpendicularly or substantially perpendicularly to said inner roller axis.
Aspect 145: The roller set according to any one of aspects 143 or 144, wherein said flange side tapers away from said third portion extending radially outwardly from said inner roller axis.
Aspect 146: The roller set according to any one of aspects 143 to 145, wherein said flange side is configured to engage an end of said pipe element.
Aspect 147: The roller set according to any one of aspects 136 to 146, wherein said fifth portion of said outer surface of said inner roller body is contiguous with (connected, either directly or through a transition region, to) said second side surface of said fifth raised feature.
Aspect 148: The roller set according to any one of aspects 140 to 147, wherein said fourth portion of said outer surface of said inner roller body is contiguous with (connected, either directly or through a transition region, to) said first side surface of said fifth raised feature and said second side surface of said fourth raised feature.
Aspect 149: The roller set according to any one of aspects 143 to 148, wherein said third portion of said outer surface of said inner roller body is contiguous with (connected, either directly or through a transition region, to) said first side surface of said fourth raised feature and said flange side of said flange.
Aspect 150: The roller set according to any one of aspects 108 to 149, wherein said third portion extends parallel or substantially parallel to said inner roller axis.
Aspect 151: The roller set according to any one of aspects 108 to 150, wherein said fourth portion extends parallel or substantially parallel to said inner roller axis.
Aspect 152: The roller set according to any one of aspects 114 to 151, wherein said fifth portion extends parallel or substantially parallel to said inner roller axis.
Aspect 153: The roller set according to any one of aspects 108 to 152, wherein said fourth raised feature is configured to form a first summit in said pipe element.
Aspect 154: The roller set according to any one of aspects 108 to 153, wherein said fifth raised feature is configured to form a second summit in said pipe element.
Aspect 155: An outer roller for use with an inner roller to form an endform of a pipe element, said outer roller engageable with an outer surface of said pipe element, said outer roller comprising an outer roller body rotatable about an outer roller axis, said outer roller body having an outer surface comprising:
a first raised feature engageable with said pipe element and extending circumferentially about said outer roller body and projecting radially away from said outer roller axis,
a second raised feature engageable with said pipe element and extending circumferentially about said outer roller body and projecting radially away from said outer roller axis,
a third raised feature engageable with said pipe element and extending circumferentially about said outer roller body and projecting radially away from said outer roller axis, said second raised feature being positioned between said first and third raised features,
a first portion positioned between said first raised feature and said second raised feature of said outer roller body, and
a second portion positioned between said second raised feature and said third raised feature of said outer roller body,
wherein a radius of said outer surface at said second portion of said outer roller body is less than a radius of said outer surface at said first portion of said outer roller body.
Aspect 156: An inner roller for use with an outer roller to form an endform of a pipe element, said inner roller engageable with an inner surface of said pipe element, said inner roller comprising an inner roller body rotatable about an inner roller axis, said inner roller body having an outer surface comprising:
a flange extending circumferentially around said inner roller body and projecting transversely to said inner roller axis,
a fourth raised feature engageable with said pipe element and extending circumferentially about said inner roller body and projecting radially away from said inner roller axis,
a fifth raised feature engageable with said pipe element and extending circumferentially about said inner roller body and projecting radially away from said inner roller axis, wherein said fourth raised feature is positioned between said flange and said fifth raised feature,
a third portion positioned between said flange and said fourth raised feature, and
a fourth portion positioned between said fourth raised feature and said fifth raised feature,
wherein said fifth raised feature has a radius greater than a radius of said fourth raised feature.
Aspect 157: The inner roller according to aspect 156, further comprising a fifth portion positioned adjacent or contiguous with said fifth raised feature.
Aspect 158: The inner roller according to any one of aspects 156 or 157, wherein said fifth raised feature comprises a tip having a curved surface.
Aspect 159: The inner roller according to aspect 158, wherein said fifth raised feature comprises a first side surface and a second side surface, said first side surface positioned between said fourth portion of said outer surface of said inner roller body and said second side surface, wherein said curved surface is contiguous with (connected, either directly or through a transition region, to) said first side surface and said second side surface.
Aspect 160: The inner roller according to aspect 159, wherein said first side surface tapers towards said second side surface extending radially outwardly away from said inner roller axis.
Aspect 161: The inner roller according to any one of aspects 159 or 160, wherein said second side surface tapers towards said first side surface extending radially outwardly away from said inner roller axis.
Aspect 162: The inner roller according to any one of aspects 156 to 161, wherein said fourth raised feature has a tip comprising a curved surface.
Aspect 163: The inner roller according to aspect 162, wherein said fourth raised feature comprises a first side surface and a second side surface, said first side surface positioned between said third portion and said second side surface, wherein said curved surface is contiguous with (connected, either directly or through a transition region, to) said first side surface and said second side surface.
Aspect 164: The inner roller according to aspect 163, wherein said second side surface extends perpendicularly or substantially perpendicularly to said inner roller axis.
Aspect 165: The inner roller according to any one of aspects 163 or 164, wherein said second side surface tapers towards said first side surface extending radially outwardly away from said inner roller axis.
Aspect 166: The inner roller according to any one of aspects 163 to 165, wherein said first side surface tapers towards said second side surface extending radially outwardly away from said inner roller axis.
Aspect 167: The inner roller according to any one of aspects 156 to 166, wherein said flange comprises a flange side.
Aspect 168: The inner roller according to aspect 167, wherein said flange side extends perpendicularly or substantially perpendicularly to said inner roller axis.
Aspect 169: The inner roller according to any one of aspects 167 or 168, wherein said flange side tapers away from said third portion extending radially outwardly from said inner roller axis.
Aspect 170: The inner roller according to any one of aspects 167 to 169, wherein said flange side is configured to engage an end of said pipe element.
Aspect 171: The inner roller according to any one of aspects 159 to 170, wherein said fifth portion of said outer surface of said inner roller body is contiguous with (connected, either directly or through a transition region, to) said second side surface of said fifth raised feature.
Aspect 172: The inner roller according to any one of aspects 163 to 171, wherein said fourth portion of said outer surface of said inner roller body is contiguous with (connected, either directly or through a transition region, to) a first side surface of said fifth raised feature and said second side surface of said fourth raised feature.
Aspect 173: The inner roller according to any one of aspects 163 to 172, wherein said third portion of said outer surface of said inner roller body is contiguous with (connected, either directly or through a transition region, to) said first side surface of said fourth raised feature and a flange side of said flange.
Aspect 174: The inner roller according to any one of aspects 156 to 173, wherein said third portion extends parallel or substantially parallel to said inner roller axis.
Aspect 175: The inner roller according to any one of aspects 156 to 174, wherein said fourth portion extends parallel or substantially parallel to said inner roller axis.
Aspect 176: The inner roller according to any one of aspects 157 to 175, wherein said fifth portion extends parallel or substantially parallel to said inner roller axis.
Aspect 177: The inner roller according to any one of aspects 156 to 176, wherein said fourth raised feature is configured to form a first summit in said pipe element.
Aspect 178: The inner roller according to any one of aspects 156 to 177, wherein said fifth raised feature is configured to form a second summit in said pipe element.
Aspect 179: A method for forming an endform of a pipe element using a roller set comprising an inner roller and an outer roller, said method comprising:
positioning an inner surface of said pipe element on said inner roller, said inner roller comprising an inner roller body rotatable about an inner roller axis, said inner roller body having an outer surface comprising a flange extending circumferentially around said inner roller body and projecting transversely to said inner roller axis, a fourth raised feature and a fifth raised feature engageable with said pipe element and extending circumferentially about said inner roller body and projecting radially away from said inner roller axis, wherein said fourth raised feature is positioned between said flange and said fifth raised feature, and wherein said fifth raised feature has a radius greater than a radius of said fourth raised feature;
moving said outer roller into contact with an outer surface of said pipe element, said outer roller comprising an outer roller body rotatable about an outer roller axis, said outer roller body having an outer surface comprising a first raised feature, a second raised feature, and a third raised feature engageable with said pipe element and extending circumferentially about said outer roller body and projecting radially away from said outer roller axis, said second raised feature positioned adjacent to said first raised feature and between said first and third raised features;
rotating said inner roller, thereby rotating said pipe element and said outer roller; and
forcing said inner and outer rollers toward one another to deform said pipe element to form said endform.
Aspect 180: The method according to aspect 179, wherein said outer roller axis and said inner roller axis are parallel or substantially parallel when forming said endform.
Aspect 181: The method according to any one of aspects 179 or 180, wherein said endform comprises a groove defined by said outer surface of said pipe element, said groove extending circumferentially around a bore of said pipe element.
Aspect 182: The method according to aspect 181, wherein said second raised feature is used to form said groove in said pipe element.
Aspect 183: The method according to any one of aspects 181 or 182, wherein said groove comprises a first groove side surface, a second groove side surface facing said first groove side surface and in spaced apart relation from said first groove side surface along a longitudinal axis of said pipe element, and a floor surface contiguous with (connected, either directly or through a transition region, to) said first groove side surface and said second groove side surface.
Aspect 184: The method according to any one of aspects 179 to 183, wherein said endform comprises a bead defined by said outer surface of said pipe element, said bead extending circumferentially around a bore of said pipe element.
Aspect 185: The method according to aspect 184, wherein said bead comprises a first bead side surface and a summit.
Aspect 186: The method according to any one of aspects 184 or 185, wherein said fifth raised feature is used to form said summit in said pipe element.
Aspect 187: The method according to any one of aspects 179 to 186, wherein said endform comprises a sealing surface defined by said outer surface of said pipe element.
Aspect 188: The method according to aspect 187, wherein said first raised feature is used to form said sealing surface in said pipe element.
Aspect 189: The method according to any one of aspects 179 to 188, wherein said second raised feature has a tip comprising a flat surface extending parallel or substantially parallel to said outer roller axis.
Aspect 190: The method according to any one of aspects 179 to 189, wherein said first raised feature has a tip comprising a frustoconical surface extending lengthwise along said outer roller body, said frustoconical surface having a smaller radius positioned proximal to said second raised feature and a larger radius positioned distal to said second raised feature.
Aspect 191: The method according to any one of aspects 179 to 190, wherein said third raised feature comprises a tip having a curved surface.
Aspect 192: The method according to any one of aspects 179 to 191, wherein said outer surface of said outer roller body comprises a first portion positioned between said first raised feature and said second raised feature, and a second portion positioned between said second raised feature and said third raised feature, wherein a radius of said outer surface at said second portion is less than a radius of said outer surface at said first portion.
Aspect 193: The method according to any one of aspects 179 to 192, wherein said outer surface of said inner roller body comprises a third portion positioned between said flange and said fourth raised feature, and a fourth portion positioned between said fourth raised feature and said fifth raised feature.
Aspect 194: The method according to aspect 193, wherein said first raised feature of said outer roller body cooperates with said third portion of said inner roller body.
Aspect 195: The method according to any one of aspects 193 or 194, wherein said first portion of said outer roller body cooperates with said fourth raised feature of said inner roller body.
Aspect 196: The method according to any one of aspects 193 to 195, wherein said second raised feature of said outer roller body cooperates with said fourth portion of said inner roller body.
Aspect 197: The method according to any one of aspects 193 to 196, wherein said second portion of said outer roller body cooperates with said fifth raised feature of said inner roller body.
Aspect 198: The method according to any one of aspects 193 to 197, wherein said third raised feature of said outer roller body cooperates with a fifth portion of said inner roller body, said fifth portion positioned adjacent or contiguous with said fifth raised feature.
Aspect 199: The method according to any one of aspects 179 to 198, further comprising contacting said flange of said inner roller with an end of said pipe element.
Aspect 200: The method according to any one of aspects 179 to 199, wherein positioning said inner surface of said pipe element on said inner roller comprises positioning said inner surface into contact with said fifth raised feature.
Aspect 201: The method according to any one of aspects 179 to 200, wherein moving said outer roller into contact with said outer surface of said pipe element comprises moving said second raised feature and said third raised feature into contact with said outer surface.
Aspect 202: The method according to any one of aspects 179 to 201, further comprising moving said first raised feature of said outer roller into contact with said outer surface of said pipe element.
Aspect 203: The method according to any one of aspects 179 to 202, wherein formation of said endform retains said pipe element in engagement with said roller set during roll forming by mechanical engagement.
Aspect 204: The method according to any one of aspects 179 to 203, further comprising, after said pipe element is formed, moving said outer roller away from said inner roller and disengaging said pipe element from said inner roller.
Aspect 205: The method according to any one of aspects 179 to 204, wherein said inner roller is a driven roller and said outer roller is an idler.
Aspect 206: The method according to any one of aspects 179 to 205, wherein said outer roller is configured to move toward and away from said inner roller.
Aspect 207: A pipe element having a sidewall surrounding a longitudinal axis and defining a bore, said sidewall having an outer surface and an inner surface, said sidewall comprising an endform formed by a process comprising:
positioning said inner surface of said pipe element on an inner roller of a roller set, said inner roller comprising an inner roller body rotatable about an inner roller axis, said inner roller body having an outer surface comprising a flange extending circumferentially around said inner roller body and projecting transversely to said inner roller axis, a fourth raised feature and a fifth raised feature engageable with said pipe element and extending circumferentially about said inner roller body and projecting radially away from said inner roller axis, wherein said fourth raised feature is positioned between said flange and said fifth raised feature, and wherein said fifth raised feature has a radius greater than a radius of said fourth raised feature;
moving an outer roller of said roller set into contact with said outer surface of said pipe element, said outer roller comprising an outer roller body rotatable about an outer roller axis, said outer roller body having an outer surface comprising a first raised feature, a second raised feature, and a third raised feature engageable with said pipe element and extending circumferentially about said outer roller body and projecting radially away from said outer roller axis, said second raised feature positioned adjacent to said first raised feature and between said first and third raised features;
rotating said inner roller, thereby rotating said pipe element and said outer roller; and
forcing said inner and outer rollers toward one another to deform said pipe element to form said endform.
Aspect 208: The pipe element according to aspect 207, wherein said endform comprises a groove defined by said outer surface, said groove extending circumferentially around said bore.
Aspect 209: The pipe element according to aspect 208, wherein said groove comprises a first groove side surface, a second groove side surface facing said first groove side surface and in spaced apart relation from said first groove side surface along said longitudinal axis, and a floor surface contiguous with (connected, either directly or through a transition region, to) said first groove side surface and said second groove side surface.
Aspect 210: The pipe element according to aspect 209, wherein said first groove side surface is oriented at a first groove side angle relative to said floor surface and said second groove side surface is oriented at a second groove side angle relative to said floor surface.
Aspect 211: The pipe element according to aspect 210, wherein said second groove side angle is greater than said first groove side angle.
Aspect 212: The pipe element according to any one of aspects 210 or 211, wherein said first groove side angle is an obtuse angle and said second groove side angle is an obtuse angle.
Aspect 213: The pipe element according to any one of aspects 208 to 212, wherein said groove is configured to flex open to receive an arcuate projection of a coupling.
Aspect 214: The pipe element according to any one of aspects 207 to 213, wherein said endform comprises a bead defined by said outer surface, said bead extending circumferentially around said bore.
Aspect 215: The pipe element according to aspect 214, wherein said bead comprises a first bead side surface and a summit.
Aspect 216: The pipe element according to aspect 215, wherein a radius of said summit is greater than any other radius of said outer surface of said endform.
Aspect 217: The pipe element according to any one of aspects 214 to 216, wherein said bead is configured to flex closed as a groove of said endform flexes open.
Aspect 218: The pipe element according to any one of aspects 207 to 217, wherein said endform comprises a sealing surface defined by said outer surface.
Aspect 219: The pipe element according to aspect 218, wherein said sealing surface is frustoconical.
Aspect 220: The pipe element according to any one of aspects 207 to 219, wherein said pipe element is a thin wall pipe.
Aspect 221: The pipe element according to any one of aspects 207 to 220, wherein said pipe element is a stainless steel pipe.
Aspect 222: The pipe element according to any one of aspects 207 to 221, wherein said outer roller axis and said inner roller axis are parallel or substantially parallel when forming said endform.
Aspect 223: The pipe element according to any one of aspects 1-40, wherein said pipe element is an elbow fitting or a tee fitting.
Aspect 224: The combination according to aspect 41, wherein said plurality of segments comprises a first segment and a second segment, wherein said first segment and said second segment are attached to one another at one end by an adjustable fastener.
Aspect 225: The combination according to aspect 41, wherein each of said segments comprises lugs projecting from opposite ends of each segment, each lug comprising a stop surface, wherein in a tightened condition, a gap remains between said stop surfaces on respective ends of said segments.
Aspect 226: The method according to aspect 72, wherein each of said segments comprises lugs projecting from opposite ends of each segment, each lug comprising a stop surface, wherein in a tightened condition, a gap remains between said stop surfaces on respective ends of said segments.
Aspect 227: A pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface of said sidewall, said groove extending circumferentially around said bore, said groove comprising:
   a first groove side surface terminating at a first end,
   a second groove side surface facing said first groove side surface and in spaced apart relation from said first groove side surface, wherein said first groove side surface is positioned between said end of said pipe element and said second groove side surface, and
   a floor surface contiguous with said first groove side surface and said second groove side surface,
   wherein said groove is configured to receive an arcuate projection of a coupling; and
a bead defined by said outer surface, said bead extending circumferentially around said bore, wherein said groove is positioned between said end of said pipe element and said bead, said bead comprising:
a first bead side surface, and
a first summit, wherein said first bead side surface is positioned between said groove and said first summit, wherein a radius of said first summit measured from said longitudinal axis is a maximum radius of a portion of said sidewall extending from said end of said pipe element to said first summit measured from said longitudinal axis.
Aspect 228: The pipe element of aspect 227, further comprising the features recited in any one of aspects 2-40.
Aspect 229: In combination, a pipe element and a coupling in a preassembled state, said pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface of said sidewall, said groove extending circumferentially around said bore, said groove comprising:
a first groove side surface,
a second groove side surface facing said first groove side surface and in spaced apart relation from said first groove side surface, wherein said first groove side surface is positioned between said end of said pipe element and said second groove side surface, and
a floor surface contiguous with said first groove side surface and said second groove side surface; and
a bead defined by said outer surface, said bead extending circumferentially around said bore, said bead comprising:
a first bead side surface adjacent or contiguous with said second groove side surface, and
a first summit having a radius measured from said longitudinal axis, wherein said first bead side surface is positioned between said first summit and said second groove side surface, wherein a radius of said first summit measured from said longitudinal axis is a maximum radius of a portion of said sidewall extending from said end of said pipe element to said first summit measured from said longitudinal axis;
said coupling comprising:
a plurality of segments attached to one another end to end surrounding a central space and said end of said pipe element;
attachment members positioned at each end of said segments for attaching said segments to one another in said preassembled state, wherein in said preassembled state, said plurality of segments are supported in spaced relation while attached to one another to allow insertion of said pipe element into said central space; and
an arcuate projection positioned on a side of each of said segments and configured to engage with said groove, said arcuate projection projecting radially inwardly from said side,
wherein, when received by said groove, said arcuate projection is configured to wedge into said groove.
Aspect 230: The combination according to aspect 229, further comprising the features recited in any one of aspects 42-71.
Aspect 231: A method of assembling a combination of a pipe element and a coupling, said pipe element having a sidewall surrounding a longitudinal axis and defining a bore, said longitudinal axis being a central axis of said pipe element, said sidewall having an outer surface comprising an endform proximate an end of said pipe element, said endform comprising a groove defined by said outer surface, said groove extending circumferentially around said bore, said endform further comprising a bead defined by said outer surface, wherein said groove is positioned between an end of said pipe element and said bead; said coupling comprising a plurality of segments attached to one another end to end to surround a central space, attachment members for attaching said segments to one another, and an arcuate projection positioned on a side of each of said segments; said method comprising:
inserting said pipe element end first into said central space of said coupling in a preassembled state until at least one of said groove and said bead engages said arcuate projection, wherein, in said preassembled state, said segments are attached to one another end to end; and
adjusting said attachment members to draw said plurality of segments from an initial condition to a tightened condition, wherein in said tightened condition, said arcuate projection wedges into said groove.
Aspect 232: The method of aspect 231, further comprising the features recited in any one of aspects 73-107.

What is claimed is:

1. A pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface of said sidewall, said groove extending circumferentially around said bore, said groove comprising:
a first groove side surface terminating at a first end,
a second groove side surface facing said first groove side surface and in spaced apart relation from said first groove side surface, wherein said first groove side surface is positioned between said end of said pipe element and said second groove side surface, and
a floor surface contiguous with said first groove side surface and said second groove side surface,
wherein said groove is configured to receive an arcuate projection of a coupling; and
a bead defined by said outer surface, said bead extending circumferentially around said bore, wherein said groove is positioned between said end of said pipe element and said bead, said bead comprising:
a first bead side surface, and
a first summit, wherein said first bead side surface is positioned between said groove and said first summit, wherein a radius of said first summit measured from said longitudinal axis is a maximum radius of a portion of said sidewall extending from said end of said pipe element to said first summit measured from said longitudinal axis.

2. The pipe element according to claim 1, wherein said first groove side surface is oriented at a first groove side angle relative to said floor surface and said second groove side surface is oriented at a second groove side angle relative to said floor surface.

3. The pipe element according to claim 2, wherein said second groove side angle is greater than said first groove side angle.

4. The pipe element according to claim 2, wherein said first groove side angle is a first obtuse angle.

5. The pipe element according to claim 2, wherein said second groove side angle is a second obtuse angle.

6. The pipe element according to claim 2, wherein said first groove side surface comprises an S-shaped profile.

7. The pipe element according to claim 1, wherein said floor surface is oriented parallel or substantially parallel to said longitudinal axis.

8. The pipe element according to claim 1, wherein a radius of said floor surface measured from said longitudinal axis is less than any other radius of said outer surface of said endform measured from said longitudinal axis.

9. The pipe element according to claim 1, wherein a radius of said floor surface measured from said longitudinal axis is less than a minimum radius of said tubular portion measured from said longitudinal axis.

10. The pipe element according to claim 1, wherein said radius of said first summit measured from said longitudinal axis is greater than a maximum radius of said tubular portion measured from said longitudinal axis.

11. The pipe element according to claim 1, wherein said radius of said first summit measured from said longitudinal axis is a maximum radius of said outer surface of a portion of said sidewall extending from said end of said pipe element to said first summit measured from said longitudinal axis.

12. The pipe element according to claim 1, wherein said first bead side surface is contiguous with said second groove side surface.

13. The pipe element according to claim 2, wherein said second groove side surface and said first bead side surface are oriented at the same or substantially the same angle relative to said floor surface.

14. The pipe element according to claim 1, wherein said groove is configured to flex open to receive said arcuate projection of said coupling, wherein said bead is configured to flex closed as said groove flexes open.

15. The pipe element according to claim 1, wherein said bead has a geometry that causes said bead to act like a spring such that a base end of said first bead side surface is axially biased towards said end of said pipe element.

16. The pipe element according to claim 1, wherein said bead further comprises a second bead side surface extending from said first summit toward said tubular portion, wherein said first summit is positioned between said first bead side surface and said second bead side surface.

17. The pipe element according to claim 16, wherein said second bead side surface has a larger radius measured from said longitudinal axis at a point closer to said first summit than at a point farther from said first summit.

18. The pipe element according to claim 16, wherein said tubular portion is contiguous with said second bead side surface.

19. The pipe element according to claim 16, wherein said endform further comprises an indent contiguous with said second bead side surface.

20. The pipe element according to claim 19, wherein said indent is positioned between said second bead side surface and said tubular portion.

21. The pipe element according to claim 1, wherein said first bead side surface extends from said second groove side surface to said first summit.

22. The pipe element according to claim 1, wherein said first end of said first groove side surface is a second summit, wherein a radius of said first summit measured from said longitudinal axis is greater than a radius of said second summit measured from said longitudinal axis.

23. The pipe element according to claim 1, wherein said endform further comprises a sealing surface positioned between said first groove side surface and said end of said pipe element.

24. The pipe element according to claim 23, wherein said sealing surface extends from said first groove side surface to said end of said pipe element.

25. The pipe element according to claim 23, wherein said sealing surface is frustoconical.

26. The pipe element according to claim 25, wherein a radius of said sealing surface measured from said longitudinal axis at a first point is less than a radius of said sealing surface measured from said longitudinal axis at a second point, wherein said first point is closer to said end of said pipe element than said second point to said end of said pipe element.

27. The pipe element according to claim 25, wherein a radius of said sealing surface measured from said longitudinal axis at a first point is larger than a radius of said sealing surface measured from said longitudinal axis at a second point, wherein said first point is closer to said end of said pipe element than said second point to said end of said pipe element.

28. The pipe element according to claim 23, wherein said sealing surface is cylindrical or substantially cylindrical.

29. The pipe element according to claim 22, wherein said endform further comprises a sealing surface positioned between said second summit and said end of said pipe element.

30. The pipe element according to claim 29, wherein said sealing surface extends from said second summit to said end of said pipe element.

31. The pipe element according to claim 29, wherein said sealing surface is frustoconical such that said sealing surface has a smaller radius measured from said longitudinal axis at a point closer to said end of said pipe element than at a point further from said end of said pipe element.

32. The pipe element according to claim 1, wherein said pipe element comprises a fitting selected from a group consisting of an elbow fitting and a tee fitting.

33. The pipe element according to claim 1, wherein said pipe element is a stainless steel pipe.

34. The pipe element according to claim 1, wherein said radius of said floor surface of said groove measured from said longitudinal axis is less than any other radius of said outer surface of said endform measured from said longitudinal axis.

35. The pipe element according to claim 1, wherein said radius of said floor surface of said groove measured from said longitudinal axis is less than a minimum radius of said outer surface of said tubular portion measured from said longitudinal axis.

36. In combination, a pipe element and a coupling in a preassembled state, said pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface of said sidewall, said groove extending circumferentially around said bore, said groove comprising:
a first groove side surface,
a second groove side surface facing said first groove side surface and in spaced apart relation from said first groove side surface, wherein said first groove side surface is positioned between said end of said pipe element and said second groove side surface, and
a floor surface contiguous with said first groove side surface and said second groove side surface; and
a bead defined by said outer surface, said bead extending circumferentially around said bore, said bead comprising:
a first bead side surface adjacent or contiguous with said second groove side surface, and
a first summit having a radius measured from said longitudinal axis, wherein said first bead side surface is positioned between said first summit and said second groove side surface, wherein a radius of said first summit measured from said longitudinal axis is a maximum radius of a portion of said sidewall extending from said end of said pipe element to said first summit measured from said longitudinal axis;
said coupling comprising:
a plurality of segments attached to one another end to end surrounding a central space and said end of said pipe element;
attachment members positioned at each end of said segments for attaching said segments to one another in said preassembled state, wherein in said preassembled state, said plurality of segments are supported in spaced relation while attached to one another to allow insertion of said pipe element into said central space; and
an arcuate projection positioned on a side of each of said segments and configured to engage with said groove, said arcuate projection projecting radially inwardly from said side,
wherein, when received by said groove, said arcuate projection is configured to wedge into said groove.

37. The combination according to claim 36, wherein, when said end of said pipe element is inserted into said central space of said coupling in said preassembled state, said radius of said first summit is greater than a linear distance measured from said longitudinal axis to at least a portion of said arcuate projection of said coupling such that said arcuate projection engages at least one of said second groove side surface and said first bead side surface and said pipe element is prevented from moving farther into said central space.

38. The combination according to claim 37, wherein said arcuate projection comprises:
a first mating surface configured to engage said first groove side surface,
a second mating surface facing away from said first mating surface and configured to engage said second groove side surface, and
a third mating surface contiguous with said first mating surface and said second mating surface and facing said central space, said third mating surface positioned between said first mating surface and said second mating surface,

39. The combination according to claim 38, wherein, when said end of said pipe element is inserted into said central space of said coupling in said preassembled state, said radius of said summit measured from said longitudinal axis is greater than a linear distance measured from said longitudinal axis to said third mating surface of said arcuate projection, said linear distance extending along an axis parallel or substantially parallel to said radius of said summit such that said arcuate projection engages at least one of said second groove side surface and said first bead side surface and said pipe element is prevented from moving farther into said central space.

40. The combination according to claim 36, wherein said first groove side surface is oriented at a first groove side angle relative to said floor surface and said second groove side surface is oriented at a second groove side angle relative to said floor surface.

41. The combination according to claim 40, wherein said second groove side angle is greater than said first groove side angle.

42. The combination according to claim 40, wherein said first groove side angle is an obtuse angle and said second groove side angle is an obtuse angle.

43. The combination according to claim 39, wherein said floor surface has a width extending parallel or substantially parallel to said longitudinal axis, wherein said third mating surface has a width extending perpendicularly or substantially perpendicularly to the length of said arcuate projection, wherein said width of said third mating surface is greater than said width of said floor surface of said groove.

44. The combination according to claim 39, wherein said third mating surface has a width extending perpendicularly or substantially perpendicularly to the length of said arcuate projection, wherein said first mating surface tapers towards said second mating surface and said second mating surface tapers towards said first mating surface such that a base of said arcuate projection is wider than said width of said third mating surface.

45. The combination according to claim 39, wherein said plurality of segments are configured to be drawn towards one another from an initial condition to a tightened condition.

46. The combination according to claim 45, wherein in said initial condition, said third mating surface is spaced from said floor surface of said groove by a first distance, and in said tightened condition, said third mating surface engages said floor surface of said groove or said third mating surface is spaced from said floor surface of said groove by a second distance, wherein said second distance is less than said first distance.

47. The combination according to claim 45, wherein said first mating surface and said second mating surface are configured to engage said first groove side surface and said second groove side surface, respectively, before said segments reach said tightened condition.

48. The combination according to claim 45, wherein said arcuate projection is configured to wedge into said groove as said segments are drawn towards each other to said tightened condition.

49. The combination according to claim 47, wherein, in an intermediate condition before said segments reach said tightened condition, said first mating surface and said second mating surface engage said first groove side surface and said second groove side surface, respectively, and said third mating surface is spaced from said floor surface of said groove by a third distance, wherein said second distance is less than said third distance.

50. The combination according to claim 46, wherein in said tightened condition and in a cross-sectional plane including said longitudinal axis, at least a portion of said arcuate projection has a width extending parallel or substantially parallel to the longitudinal axis configured to cause the arcuate projection to forcefully contact said first groove side surface and said second groove side surface at a contact point, wherein, in said initial condition and in said cross-sectional plane including said longitudinal axis, said groove has a width extending parallel or substantially parallel to the longitudinal axis at the same or substantially same location as the point of contact that is less than said width of said arcuate projection.

51. The combination according to claim 46, wherein said first groove side surface terminates at a first end and said second groove side surface terminates at a second end, wherein said first end of said first groove side surface and said second end of said second groove side surface are not contiguous with said floor surface, wherein in said tightened condition and in a cross-sectional plane including said longitudinal axis, a cross-sectional area of said arcuate projection is defined by said first mating surface, said second mating surface, and a first plane intersecting the first end of the first groove side surface and the second end of said second groove side surface, wherein, in said initial condition and in said cross-sectional plane including said longitudinal axis, a cross-sectional area of said groove is defined by said first groove side surface, said second groove side surface, and a second plane intersecting said first end of said first groove side surface and said second end of said second groove side surface, wherein said cross-section area of said arcuate projection is greater than said cross-section area of said groove.

52. The combination according to claim 36, wherein in said preassembled state, said plurality of segments are supported in spaced relation while attached to one another to allow insertion of said pipe element into said central space.

53. The combination according to claim 52, wherein said coupling comprises a ring seal configured to support said plurality of segments in said preassembled state.

54. The combination according to claim 36, wherein said plurality of segments comprises a first segment and a second segment, wherein said first segment and said second segment are attached to one another at one end by an adjustable fastener.

55. The combination according to claim 36, wherein said plurality of segments comprises more than two segments attached to one another end to end to surround said central space.

56. The combination according to claim 36, wherein said plurality of segments comprises a first segment and a second segment, wherein said first segment and said second segment are attached to one another at both ends by adjustable fasteners.

57. The combination according to claim 36, wherein each of said segments comprises lugs projecting from opposite ends of each segment, each lug comprising a stop surface, wherein in a tightened condition, said stop surfaces on respective ends of said segments engage each other.

58. The combination according to claim 36, wherein said coupling comprises a ring seal configured to be captured and compressed between said segments and said pipe element when said attachment members are tightened.

59. The combination according to claim 58, wherein said ring seal does not comprise a tongue or center leg.

60. The combination according to claim 45, wherein in said tightened condition, said first mating surface is received within said groove.

61. The combination according to claim 60, wherein in said tightened condition, said first mating surface engages said first groove side surface.

62. The combination according to claim 60, wherein in said tightened condition, said second mating surface engages said second groove side surface.

63. The combination according to claim 60, wherein in said tightened condition, said third mating surface engages said floor surface.

64. The combination according to claim 36, wherein each of said segments comprises lugs projecting from opposite ends of each segment, each lug comprising a stop surface, wherein in a tightened condition, a gap remains between said stop surfaces on respective ends of said segments.

65. The combination according to claim 36, wherein said pipe element is a stainless steel pipe.

66. The combination according to claim 36, wherein said wedging action of said arcuate projection and said groove around the circumference of said pipe element promotes a more rigid joint.

67. A method of assembling a combination of a pipe element and a coupling, said pipe element having a sidewall surrounding a longitudinal axis and defining a bore, said longitudinal axis being a central axis of said pipe element, said sidewall having an outer surface comprising an endform proximate an end of said pipe element, said endform comprising a groove defined by said outer surface, said groove extending circumferentially around said bore, said endform further comprising a bead defined by said outer surface, wherein said groove is positioned between an end of said pipe element and said bead; said coupling comprising a plurality of segments attached to one another end to end to surround a central space, attachment members for attaching said segments to one another, and an arcuate projection positioned on a side of each of said segments; said method comprising:
inserting said pipe element end first into said central space of said coupling in a preassembled state until at least one of said groove and said bead engages said arcuate projection, wherein, in said preassembled state, said segments are attached to one another end to end; and
adjusting said attachment members to draw said plurality of segments from an initial condition to a tightened condition, wherein in said tightened condition, said arcuate projection wedges into said groove.

68. The method according to claim 67, wherein said bead comprises a first summit having a radius measured from said longitudinal axis, and wherein said radius of said first summit is greater than a linear distance measured from said longitudinal axis to said arcuate projection when said coupling is in said preassembled state and said end of said pipe element is inserted into said central space such that said pipe element is prevented from moving further into said central space upon said engagement of at least one of said groove and said bead with said arcuate projection.

69. The method according to claim 67, wherein said arcuate projection slides along at least one of said groove and said bead as said attachment members are adjusted to align said arcuate projection and said groove.

70. A method of forming a pipe element having a sidewall surrounding a longitudinal axis and defining a bore, said longitudinal axis being a central axis of said pipe element, said sidewall having an outer surface and an inner surface, said method comprising:
positioning said inner surface of said pipe element on an inner roller of a roller set, said inner roller comprising an inner roller body rotatable about a second axis;
moving an outer roller of said roller set into contact with said outer surface of said pipe element, said outer roller comprising an outer roller body rotatable about a first axis;
rotating said inner roller, thereby rotating said pipe element and said outer roller; and
forcing said inner and outer rollers toward one another to deform said pipe element to form an endform comprising:
a groove defined by said outer surface proximate an end of said pipe element, said groove extending circumferentially around said bore, said groove comprising a first groove side surface, a second groove side surface facing said first groove side surface and in spaced apart relation from said first groove side surface, and a floor surface contiguous with said first groove side surface and said second groove side surface, wherein said first groove side surface and said second groove side surface are configured to receive and wedge an arcuate projection of a coupling; and
a bead defined by said outer surface, said bead adjacent or contiguous with said groove, said bead comprising a first bead side surface and a summit, wherein said groove is positioned between said end of said pipe element and said bead, and wherein said first bead side surface is positioned between said summit and said second groove side surface.
